(19) United States
(12) Patent Application Publication
(10) Pub. No.: US 2023/0266753 A1
(43) Pub. Date: Aug. 24, 2023

(54) Next-Generation Cross-Platform for Uncrewed Systems

(71) Applicant: The Government of the United States of America, as represented by the Secretary of the Navy, Arlington, VA (US)

(72) Inventors: Blake J. Landry, Saint Martinville, LA (US); William David Null, Urbana, IL (US)

(73) Assignee: The Government of the United States of America, as represented by the Secretary of the Navy, Arlington, VA (US)

(21) Appl. No.: 17/961,382

(22) Filed: Oct. 6, 2022

Related U.S. Application Data
(60) Provisional application No. 63/253,082, filed on Oct. 6, 2021.

(51) Int. Cl. G05D 1/00

(52) U.S. Cl. CPC G05D 1/0016; G05D 1/0022; G05D 1/0088; G05D 2201/0207

(57) ABSTRACT

A system having a networking device, a plurality of processing devices, and one or more unmanned devices, wherein each unmanned device couples to a corresponding one of the processing devices, wherein each unmanned device comprises one or more operational components. The system having a controller device configured to control at least one of the one or more unmanned devices via the networking device and the corresponding one of the processing devices, the controller device comprising one of the processing devices, wherein the controlled at least one unmanned device is configurable via the corresponding processing device in a control operating mode or in a robot operating mode, the control operating mode enabling the associated unmanned device to perform commands received from the controller device via the corresponding processing device, and the robot operating mode enabling the unmanned device to receive programmable instructions from the controller device via the corresponding processing device.

### CROSS-REFERENCE

This Application is a nonprovisional application of and claims the benefit of priority under 35 U.S.C. § 119 based on U.S. Provisional Pat. Application No. 63/253,082 filed on Oct. 6, 2021. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case # 210827.

### TECHNICAL FIELD

The present disclosure is related to an unmanned vehicle system, and more specifically to, but not limited to, a platform agnostic robotic system.

### BACKGROUND

An existing open source control framework, Robot Operating System, ROS, (https://www.ros.org/) is popular for unmanned systems. While powerful and extremely capable, it has a steep learning curve, and ROS is not optimized to run on low-cost educational hardware such as the Raspberry Pi. ROS also does not provide enough abstraction to be effective in teaching high level concepts to introductory learners. On the other hand, there are some robots designed to be programmed using Scratch (https://scratch.mit.edu/) coding blocks. While easy to understand and modify, Scratch does not provide teachers with the ability to help students see and understand the underlying code operating the robots. NEXUS provides a balance of abstracted robot building blocks with accessible application programming interface (APIs) so that high level programming and control concepts can be implemented by beginners and teachers can demonstrate how those high level commands are carried out on the actual robot.

Robot Operating System, ROS, (https://www.ros.org/) is popular for robotic systems. While powerful and extremely capable, it has the following shortcomings:
Steep learning curve
Lacks ability to readily enable complete system level integration (out-of-the box)
ROS is not optimized to run on COTS hardware

MOOS (https://sites.google.com/site/moossoftware/) is a C++ cross platform middle ware for robotics research.
MOOS is restrictive due to C++ code base.
Lacks ability to readily enable complete system level integration (out-of-the box)

Scratch (https://scratch.mit.edu/) is another more simplistic framework. It uses the concept of coding blocks. While easy to understand and modify, Scratch is limited and lacks complexity to enable advanced robotics functions and operations.

There exists a need for a “virtual sandbox” to allow user/operators to be exposed to the challenges associated with multi-UxS deployments as well as explore and develop hardware, strategies, and algorithms for coordinated teams of heterogeneous unmanned systems.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

Disclosed aspects provide for a system comprising a networking device, a plurality of processing devices, one or more unmanned devices, wherein each unmanned device couples to a corresponding one of the processing devices, wherein each unmanned device comprises one or more operational components, and a controller device. The controller device may be configured to control at least one of the one or more unmanned devices via the networking device and the corresponding one of the processing devices, the controller device comprising one of the processing devices, wherein the controlled at least one unmanned device is configurable via the corresponding processing device in a control operating mode or in a robot operating mode, the control operating mode enabling the associated unmanned device to perform commands received from the controller device via the corresponding processing device, and the robot operating mode enabling the unmanned device to receive programmable instructions from the controller device via the corresponding processing device. Each of the processing devices may include memory storing executable instructions, the processing devices being configured to (i) define one or more of the operational components to be used by an unmanned device, (ii) map one or interactive input elements of an input device to a corresponding coded function, and (iii) define one or more actions for corresponding actuations of the one or more interactive input elements, wherein each processing device may be configured with a common software image enabling the controller device to control the one or more unmanned devices responsive to configuring the controller device with an IP address associated with each of the one or more unmanned devices.

### BRIEF DESCRIPTION OF THE DRAWINGS

FIG. 1 illustrates an example schematic diagram of an example NEXUS system in accordance with disclosed aspects.

FIG. 2 illustrates an example of layers of user engagement, skill levels, and learning, in accordance with disclosed aspects.

FIG. 3 illustrates an example NEXUS node device in accordance with disclosed aspects.

FIG. 4 illustrates an example motor control component, in accordance with disclosed aspects.

FIG. 5 illustrates an example wiring configuration, in accordance with disclosed aspects.

FIG. 6 illustrates an example method, in accordance with disclosed aspects.

FIG. 7 illustrates a schematic diagram of three programmable files, in accordance with disclosed aspects.

FIG. 8 illustrates a schematic diagram for building a first file, in accordance with disclosed aspects.

FIG. 9 illustrates a schematic diagram for building a second file, in accordance with disclosed aspects.

FIG. 10 illustrates a schematic diagram for building a third file, in accordance with disclosed aspects.

FIG. 11 illustrates a NEXUS system example, in accordance with disclosed aspects.

FIG. 12 illustrates a NEXUS system example, in accordance with disclosed aspects.

FIG. 13 illustrates a flow schematic block diagram of a NEXUS system example, in accordance with disclosed aspects.

FIGS. 14A-E illustrate examples of NEXUS architecture, in accordance with disclosed aspects.

FIG. 15 illustrates an example NEXUS graphical-user interface (GUI), in accordance with disclosed aspects.

FIG. 16 illustrates an example computer system, in accordance with disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The Next-generation Educational cross-platform for Uncrewed (or Unmanned) Systems (NEXUS), and/or Next-generation cross-platform for Uncrewed (or Unmanned) Systems, provides a common command and control (C2) framework for developing, operating, and coordinating uncrewed systems which leverages commercial off-the-shelf (COTS) hardware components. The NEXUS system, and/or framework, is designed to be open source, wireless, and platform agnostic which can be used for marine, aerial, and/or land-based robotic systems without tethers between the robot platform and command station.

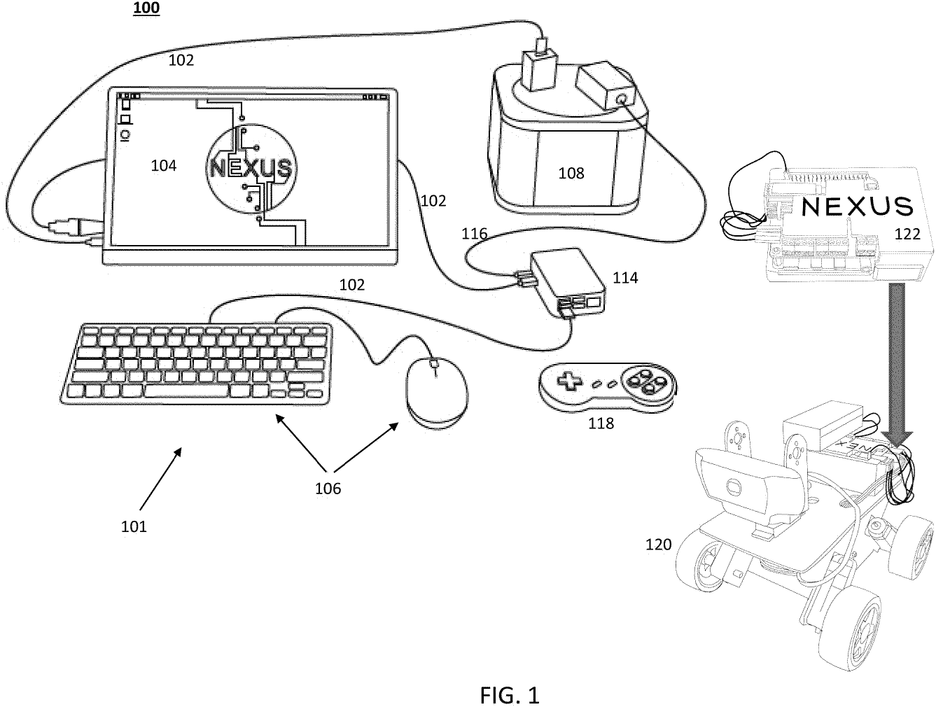

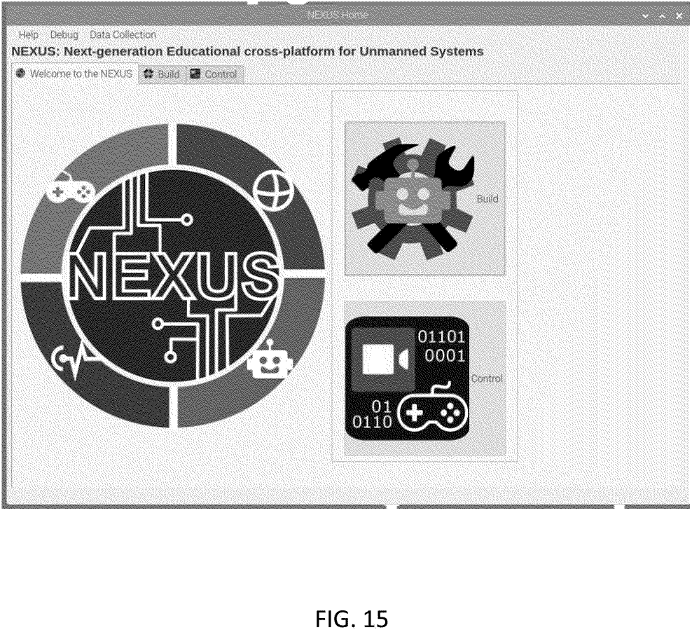

FIG. 1 illustrates an example schematic diagram of an example NEXUS system 100 in accordance with disclosed aspects. System 100 may include a control terminal system 101, which may include one or more connecting devices 102 (e.g., Micro-HDMI to HDMI cable, or the like), monitor 104 (e.g., showing a NEXUS GUI, such as shown in FIG. 15), input device(s) 106 (e.g., keyboard, mouse, etc.), monitor power adapter 108, monitor power cable 110, NEXUS node device 114 (e.g., raspberry Pi 4 model B or the like), PCB power cable/adapter/switch 116, and controller device 118 (gamepad). System 100 may include an unmanned device 120, which may include a NEXUS node device 122, which may include or be a PCB. Unmanned device 120/node device 122 can communicate with control terminal system 101 (e.g., includes NEXUS node device 114), such as via a network device. According to some aspects, node device 122 may be NEXUS Node 01 (e.g., acting as robot node), and node device 114 may be NEXUS Node 02 (e.g., acting as control node). According to some aspects, two NEXUS nodes can be substantially similar or identical, however they can behave differently based on user installation and interactivity. For example, a NEXUS node can run in robot mode (e.g., act as a robot node) and a second NEXUS node can be run in control mode (e.g., act as a robot node).

The following is an example list of components that may be used in one or more embodiments:

| | |
|---|---|
| □ Wi Fi Router (e.g., Linksys AX6000) | □ Raspberry Pi Power Cable with Power Adapter |
| □ Robot Chassis | □ Micro-HDMI to HDMI Cable (for PI 4) |
| □ NEXUS Node Case (qty. 2) | □ HDMI to Mini-HDMI Adapter |
| □ NEXUS Node 01 (for robot): | □ 18650 Lithium Ion Batteries (qty. 4 minimum) |
| • Raspberry PI 4 Model B Single Board Computer (either 2 GB, 4 GB, or 8 GB models) | □ 18650 Portable Power Bank |
| • Micro SD card | □ 18650 Battery StorageCase (contains black and red wires) |
| • Pi Motor Shield Expansion Board | □ 18650 Battery Charger (eight cell count) |
| • I2C OLED Display | □ USB to USB-C Cable (length ≃ 3 inches) |
| □ NEXUS Node 02 (for command station): | □ Electrical Tape (use as needed) |
| • Raspberry Pi 4 Model B Single Board Computer (either 2 GB, 4 GB, or 8 GB models) | □ Velcro (length ≃ 6 inches) |
| • Micro SD Card | □ Zip Ties |
| • Pi Motor Shield Expansion Board [optional] | □ Small Flathead Screwdriver |
| • I2C OLED Display [optional] | □ Phillips Head Screwdriver |
| □ Servo Motor | □ (Optional) Raspberry PI In-line Power Switch |
| □ Fan and Tilt Servo Mount | □ (Optional) 25 ft. Power Cord Reel |
| □ USB Web Camera | □ (Optional) Breadboard |
| □ Portable Monitor: | □ (Helpful) Small Pliers |
| • USB-C Power Cable | □ (Recommend) Hot Glue Gun and Glue |
| • Power Adapter | □ (Recommend) Male Pin Headers (qty. 4) |
| □ Keyboard | □ (Recommend) Soldering Station |
| □ Mouse | □ (Recommend) Wire Cutter |
| □ Wireless Game Controllor with USB Receiver (Pi compatible) | □ (Recommend) Female-Female Jumper Wires (qty. 4) |
| □ Personal Computer [only for flashing image] | □ (Advanced) Sensor Kit. (e.g., Adept Sensor Kit) |
| □ Micro SD Card Reader | |

The inventors developed NEXLTS to address key topics relevant to current and future naval operations. The inventors developed a “sandbox” to allow users/operators to explore and develop hardware, strategies, and algorithms for coordinated UxS team operations. Disclosed embodiments can be used to inspire and educate the next generation of UxS operators and expose challenges associated with multiple UxS deployments.

Disclosed embodiments allow for programming an unmanned vehicle platform to enable autonomous operation of an individual platform or the entire diverse group of unmanned platforms (i.e., swarm dynamics). The future of naval missions can be carried out with teams of heterogeneous unmanned systems (UxS). Typical present-day unmanned systems operations focus on deploying (and developing) a single unmanned system to accomplish mission objectives. Each unmanned system is often complex, expensive, and not initially designed to coordinate information and actions with another dissimilar unmanned system to accomplish a common objective.

Disclosed embodiments provide for a Next-generation Educational cross-platform for Uncrewed Systems (NEXUS). NEXUS provides a common command and control (C2) framework for developing, operating, and coordinating uncrewed systems which leverages commercial off-the-shelf (COTS) hardware components. The NEXUS framework is designed to be open source, wireless, and platform agnostic which can be used for marine, aerial, and/or land-based robotic systems without tethers between the robot platform and command station.

Uncrewed systems enhance the shared awareness of events (environmental or living) in various types of mission target areas, especially in dynamic, uncertain, and harsh environments. See Mahmod, P. O. F. C. M. Unmanned A.I U.S. Central Command Public Affairs, May 2022. https://www.centcom.mil/MEDIA/VIDEO-AND-IMAGERY/VIDEOS/videoid/843262/dvpcc/false/#DVIDSVideoPlayerl276; Unmanned Campaign Framework Department of the Navy (2021); Science and Technology Strategy for Intelligent Autonomous Systems Department of the Navy (2021).

Present-day naval operations (as well as training opportunities) focus on utilizing a single, unscrewed system (UxS). See Unmanned Campaign Framework Department of the Navy (2021). The future of naval missions can be carried out with teams of uncrewed systems (heterogeneous UxS units). See Mahmod, P. O. F. C. M. Unmanned A.I U.S. Central Command Public Affairs, May 2022. https://www.centcom.mil/MEDIA/VIDEO-AND-IMAGERY/VIDEOS/videoid/843262/dvpcc/false/#DVIDSVideoPlayer1276; Unmanned Campaign Framework Department of the Navy (2021). The Navy’s envisioned framework for future implementation includes a narrative shift from a platform-centric to a capability-centric approach that produces total solutions including effective enablers (such as personnel, networks, infrastructure, etc.). See Unmanned Campaign Framework Department of the Navy (2021).

The disclosed embodiments directly address the educational, training, and workforce developmental aspects of the naval challenge to coordinate and communicate across the full range of uncrewed systems operated by naval forces. The disclosed embodiments are also in line with the desired narrative shift towards a capability-centric, modular, and open system approach for unmanned systems. See Unmanned Campaign Framework Department of the Navy (2021). The future of naval operations is the orchestrated coordination of a fleet of different uncrewed systems (air, surface, and subsurface vessels) working together to accomplish a common goal. See Mahmod, P. O. F. C. M. Unmanned A.I U.S. Central Command Public Affairs, May 2022. https://www.centcom.mil/MEDIA/VIDEO-AND-IMAGERY/VIDEOS/videoid/843262/dvpcc/false/#DVIDSVideoPlayerl276; Unmanned Campaign Framework Department of the Navy (2021).

Uncrewed systems enhance battlefield awareness while increasing personnel safety with their ability to monitor current events at sea more continuously given the proper support systems. See Mahmod, P. O. F. C. M. Unmanned A.I U.S. Central Command Public Affairs, May 2022. https://www.centcom.mil/MEDIA/VIDEO-AND-IMAGERY/VIDEOS/videoid/843262/dvpcc/false/#DVIDSVideoPlayerl276; Unmanned Campaign Framework Department of the Navy (2021); Science and Technology Strategy for Intelligent Autonomous Systems Department of the Navy (2021). Typical UxS operations focus on deploying (and developing) a single UxS to accomplish mission objectives. See Unmanned Campaign Framework Department of the Navy (2021). However, interoperability, information fusion, and communication between distinctly unique and distributed uncrewed systems in a forward operating area is critical and represents an ongoing, real-world challenge for Naval forces. See Unmanned Campaign Framework Department of the Navy (2021); Science and Technology Strategy for Intelligent Autonomous Systems Department of the Navy (2021).

Disclosed embodiments provide for Operating System (OS) images with NEXUS preinstalled. The user simply inserts the NEXUS image into a system-on-chip, SOCs, (e.g., Raspberry Pi) and boot the system using the image. The NEXUS framework turns the system into a NEXUS “node” and allows command and control (C2) between any node(s) on the network. By default nodes are Robot nodes (awaiting user commands or executing preprogrammed instructions) and users can turn any node into a Command Station node by clicking a desktop icon or modifying a settings parameter. The ability to enable C2 between different unmanned systems provides a broad range of educational, engineering, scientific, and defense applications. NEXUS provides a compact, user-friendly, and cost effective way to enable C2 on heterogeneous robotic platforms.

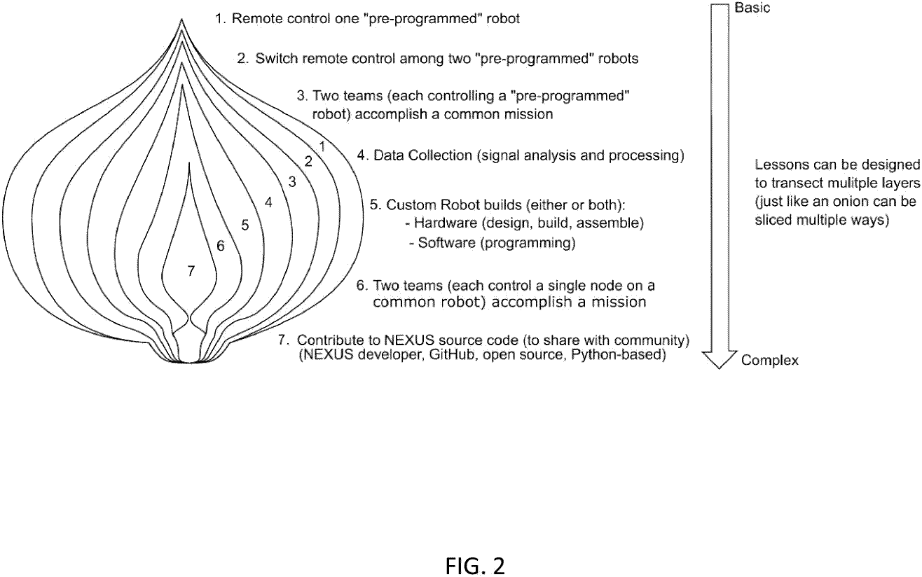

NEXUS is fundamentally designed to provide multiple layers of user engagement, skill levels, and learning that build on each other as one dives deeper into NEXUS and “peels” away each layer, such as shown in FIG. 2. At basic user skill levels, the NEXUS framework can allow multiple users to operate a vehicle platform while simultaneously exposing them to communication challenges associated with manually operating and coordinating differently-configured vehicle platforms to execute a common mission.

At intermediate user skill levels, users can plan and develop custom vehicle platforms made out of affordable materials commonly available at craft, grocery, and hardware stores. Users can also design parts using 3D printers and laser cutters which exposes individuals to the Engineering Design Cycle where they can use immediate feedback to improve their prototypes. At advanced user skill levels, users can program each unmanned vehicle platform to enable autonomous operation of an individual platform or the entire diverse group of unmanned platforms (i.e., swarm dynamics).

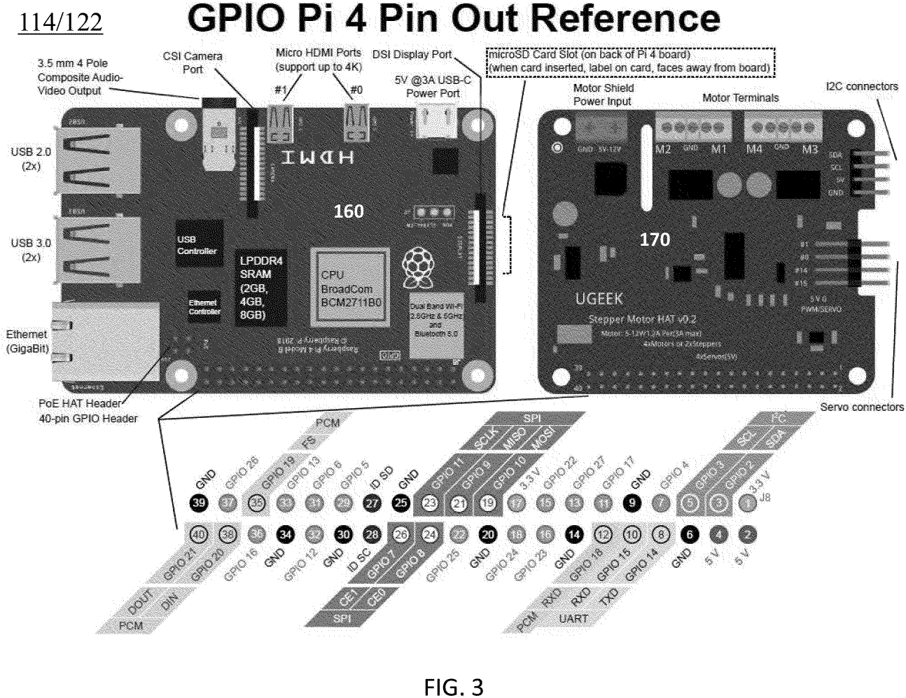

FIG. 3 illustrates an example node device 114/122, which may, in one example, be a GPIO Pi 4 Pin Out Reference, in accordance with disclosed aspects. Node device 114/122 may include a PCB/SBC component 160 (e.g., GPIO board) and a motor control component 170 (e.g., stepper motor HAT). FIG. 3 illustrates example connection points and components of the PCB component 160 and the motor control component 170. According to some aspects, the SBC 160 handles processing and communications and interfaces a hardware connection with the camera and motor control component 170. The motor control component 170, interfaces via a hardware connection for various robot components (e.g., motors, servos, and/or sensors, etc.)

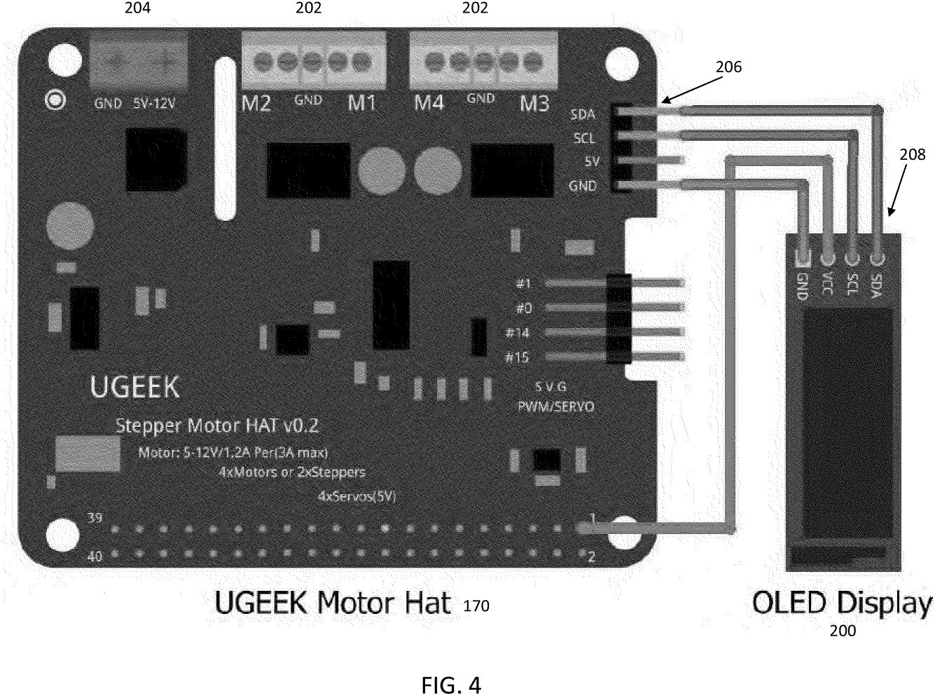

FIG. 4 illustrates the motor control component 170 connected to a display device 200 in accordance with disclosed aspects, such as via an I2C interface. Stepper motor HAT component 170 may include one or more terminal blocks 202 M2, M1, M4, and M3. Stepper motor HAT component 170 may include a terminal block 204 (e.g., labeled “5 V-12 V and GND”). Display device 200 may be an OLED display in one embodiment. The SDA, SCL, Voltage, and Ground terminals 206 may be connected to the corresponding terminals 208 on the display device 200. In some embodiments, the voltage terminal (VCC) of the display device may be connected to a separate terminal receiving power, such as labeled “1.” For example, the display may require a 3.3 V power input and might not be wired to the 5 V line.

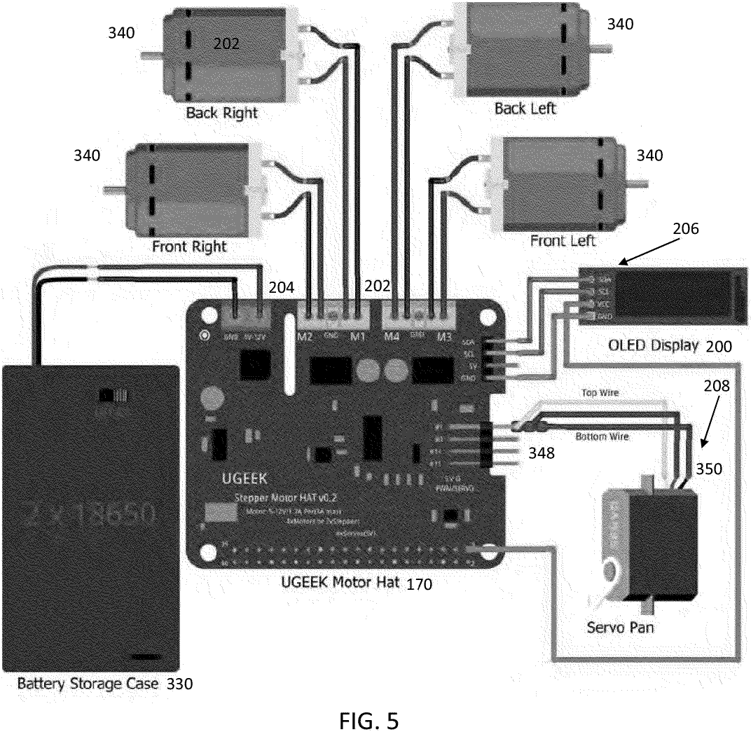

FIG. 5 illustrates an example wiring configuration for device 170 in accordance with disclosed aspects. In some embodiments the device 170 may include a power device 330, which may include 18650 Lithium-Ion Batteries (qty. 4 minimum), a 18650 Portable Power Bank, a 18650 Battery Storage Case (contains black and red wires), a 18650 Battery Charger (eight cell count), a USB to USB-C Cable (length ≈ 3 inches), and/or the like. Power device may be connected to terminal blocks 204. One or more servo motors 340 may be connected to terminal blocks 202 and may be coupled to a respective wheel. When the device 170 is fully powered, the servo motors 340 may react and the display 200 may display the Raspberry Pi’s IP address. In some embodiments, device 170 may be connected to DC motors 340 and battery 330 via standard power connections. The power device 330 may be connected to blue terminal block 204. The motors 340 may be connected to terminal blocks 202 (i.e., respectively coupled). A servo pan 346 may be connected to the device 170 via terminals 348 and 350.

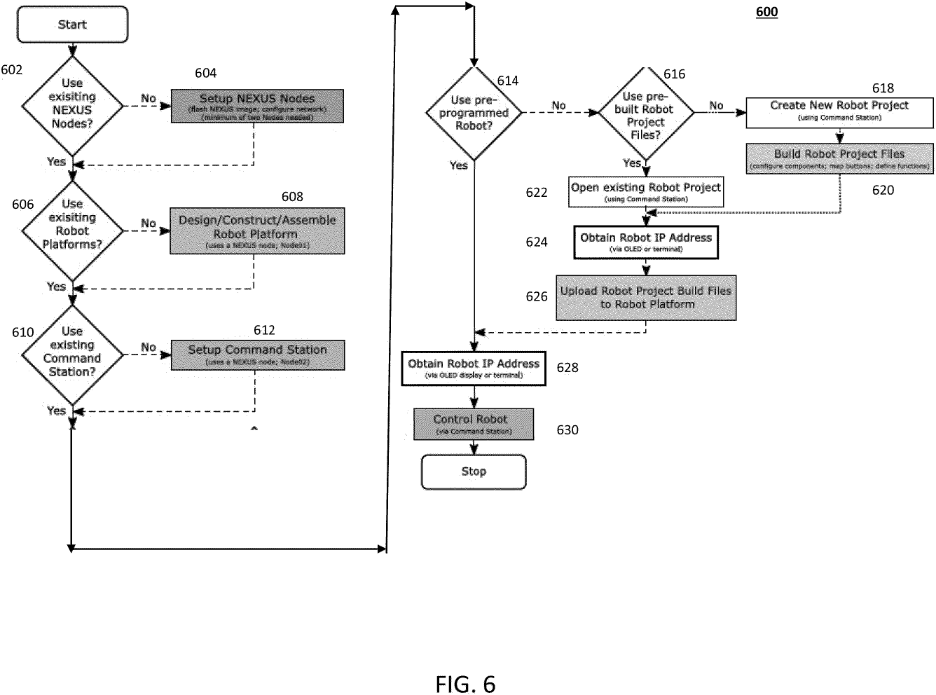

FIG. 6 illustrates an example method 600 for NEXUS in accordance with disclosed aspects. Step 602 may include determining whether to use existing nexus nodes. If it is determined to not use existing nexus nodes, then at step 604, a user may set up one or more NEXUS Nodes (e.g., further described herein). If there are no NEXUS nodes to set up, then at step 606, it is determined whether to use existing robot platforms. If it is determined to not use existing robot platforms, then at step 608, the user may build a robot platform (e.g., further described herein). If there are existing robot platforms, then at step 610, it is determined whether to use an existing command station. If it is determined to not use an existing command station, then at step 612, the user may set up a command station (e.g., further described herein). If it is determined to use an existing command station, then at step 614, it is determined whether to use a pre-programmed robot. If it is determined to not use a pre-programmed robot, then at step 616, it is determined whether to use pre-built robot project files. If it is determined to not use pre-built robot project files, then at step 618, the user may create a new robot project. At step 620, the user may build robot project files (e.g., further described herein). The process may proceed to step 624. If it is determined to use pre-built robot project files at step 616, then at step 622, the user may open an existing robot project. At step 624, a robot IP address may be obtained. At step 626, the user may upload robot project build files to robot platform (e.g., further described herein), the process may continue to step 628. If at step 614, it is determined to use a pre-programmed robot, then at step 628, the robot IP address may be obtained (if not already obtained). At step 630, the user may control a programmed NEXUS robot. The process 600 may stop. One or more steps may be repeated, added, modified, and/or excluded. According to some aspects, one or more steps may be performed by a processing device.

According to some aspects, one or more disclosed embodiments may have one or more specific applications. In some embodiments, the unmanned robot platforms can have different capabilities. For example, the robot may be a tank which can traverse over different types of terrain with a camera, a car with omni-directional wheels with a gripper, or a car which can carry cargo. For example, disclosed aspects may be used for search & rescue, for implementing and/or developing a mission route plan associated with operating a vehicle, aircraft, vessel, and/or the like. According to some aspects, one or more disclosed aspects may be used to facilitate a water-based operation. In some cases, one or more disclosed aspects may be used to facilitate a strategic operation, which can include a defensive tactical operation or naval operation.

Step 604 may include setting up one or more NEXUS nodes. The NEXUS framework provides a C2 path for nodal units to interact. When building a NEXUS Robot from scratch, the first step is to create the NEXUS Node. The NEXUS Node is the computer brains of the system, containing the NEXUS software (or “image”) and motor controls. For example, two NEXUS Nodes can be used to establish interaction between the Robot Platform and the Command Station.

This may include preparing a NEXUS image. The NEXUS Image is the software that may be installed onto the nodal units’ computers.

### 3.1.1 Gather Items for NEXUS Image

Computer running MacOS, Windows 10, or Linux
   (Note: This computer should not be a Raspberry Pi)
USB Micro SD Card Reader (included in Raspberry Pi Complete Desktop Starter Kit)
Two USB Micro SD Cards (included in Starter Kit and the Complete Desktop Starter Kit)

### 3.1.2 Obtain and Install Software

After collecting the items, obtain and install the following software using a computer:
1. Download and install the Raspberry Pi Imager software from the following website:
   https://www.raspberrypi.org/software/
2. Download the .zip file from the following website to a computer
   --URLHidden--
3. Unzip the .zip file.

### 3.1.3 Flash NEXUS Image

Conduct the following steps to install (or “flash”) the Operating System (OS) with NEXUS software onto the micro SD cards.

1. Insert the micro SD card into the micro SD card reader and connect to computer if not already connected. Note the drive letter of the SD card:

2. Run the Raspberry Pi Imager software installed in the previous step.

3. Click the “Choose OS” button.
(a) When OS option list appears, scroll down and select “Use custom” to select a custom .img file from the computer
(b) When the “Select image” file browser appears, navigate to the NEXUS-0.6.0.img
(c) Select the NEXUS-0.6.0.img and click “Open”

Now, the Raspberry Pi Imager should display the NEXUS-0.6.0.img under the Operating System option.

4. Click the “Choose Storage” button.

(a) When the Storage list options appear, select the micro SD card.

For example, “Generic STORAGE DEVICE USB DEVICE - xx.x GB”, where xx.x GB is the size of the SD card (should be close to the size of the card, for example for a labeled 32 GB card the value might show up as 31.9 GB).

Now, the Raspberry Pi Imager should display a third button, “WRITE”, to the right of the storage option.

5. Click “WRITE”.

A prompt can appear, stating “All existing data on device can be erased. Are you sure you want to continue?”

6. Click “YES” to continue.

Take note that all data on card can be deleted.

7. Wait until the writing and verifying is complete.

This can take a few minutes. Please be patient.

8. When complete, click “Continue”. The Raspberry Pi Imager can display, “You can now remove the SD card from the reader”, upon completion.

An error might occur on Windows 10 computers stating “Location not available”, this message box can be dismissed and ignored.

9. Eject this first micro SD card from reader (which now has been flashed with OS and NEXLTS image)

10. Insert the second micro SD card into the SD card reader and insert it into the computer.

11. REPEAT steps 4 to 8 above with the second micro SD card.

Two micro SD cards should be flashed with the NEXUS Image. Reminder, one can be used on the Robot Platform, the other in the Command Station.

### 3.2 Build NEXUS Nodes

Now that the NEXUS Image as been flashed to the micro SD cards, the rest of the NEXUS Nodes can be assembled. According to some aspects, the Raspberry Pi in the Robot Platform can be referred to as NEXUS Node 01, and the Raspberry Pi in the Command Station as NEXUS Node 02. In some embodiments, nodes can behave differently based on user installation and interactivity. For this example the NEXUS node that is running as a robot node is denoted as NEXUS node 01 and the NEXUS node that is running as a control node is denoted as NEXUS node 02.

Items that may be used include:

| | |
|---|---|
| □ Raspberry Pi 4 Model B Single Board Computer (either 2 GB, 4 GB, or 8 GB models) | □ Female-Female Jumper Wires (qty. 4) |
| □ Micro SD Card with NEXUS Image (refer to Section 3.1.3) | □ [Optional] Velcro |
| | □ [Recommend] Hot Glue Gun and Glue |
| □ Pi Motor Shield Expansion Board | |
| □ 12C OLED Display | □ [Recommend] Male Pin Headers (qty.4) |
| □ NEXUS Node Case | □ [Recommend] Soldering Station |

Follow the steps below to assemble the NEXUS Nodes:

1. Open the NEXUS Node case.

2. Install the Raspberry Pi into the case:

(a) Place the Raspberry Pi computer at the bottom of the case (pay attention to case orientation, make sure the micro SD card slot on the bottom of the Pi can still be accessed).

(b) Press down until it snaps into place (this may take more downward force than presumed).

3. Install the motor shield expansion board:

(a) Place the jack-screw sockets on top of the four large holes on the Raspberry Pi and tighten the washers underneath the board in order to secure the sockets in place.

(b) Place the motor shield on top of the Raspberry Pi and gently push it down into place.

(c) Tighten the screws into the jack-screw sockets to secure the motor shield to the Raspberry Pi.

4. Snap the top case cover into place.

5. Install the OLED display:

(a) Verify the metal pins are attached to the OLED display, if not follow appendix B.3 to solder the male header pins to the OLED.

(b) Use four female-female jumper wires to connect the OLED display to the “P9” pins on the motor shield.

(c) Do not plug anything into the “5 V” pin.

(d) Connect the last pin labeled “VCC” to the first header pin on the GPIO Board.

(e) Affix the OLED display into the slot on the NEXUS Node Case (recommend using hot glue or Velcro).

6. Insert the micro SD card into the slot on the bottom of the Raspberry Pi computer.

7. Repeat all steps above to assemble the second NEXUS node.

Two NEXUS Nodes should now be completely assembled. The nodes should not have any power connected to them. Turning on the nodes can occur after it is given a role (Robot Platform or Command Station) by connecting it to the platform hardware.

### 3.3 Configure NEXUS Network

Now that the NEXUS Node hardware is assembled, the wireless network can be configured to allow communications between the two nodes. In some cases, a plurality of nodes (e.g., some or all nodes) may to be connected to the same Wi-Fi network, such as via a network device like a router. Reminder, NEXUS can be used with more than two nodes and be customized to the mission. For ease of large deployments with numerous NEXUS Nodes, the NEXUS Image is preset to a standard NEXUS Wi-Fi network. In some cases, the wireless router may be configured to automatically connect to one or more node, and in some cases, to every NEXUS Node.

If using a wireless device to access the web interface, make sure the router is ON and the device is connected to the router’s Wi-Fi before following the steps below. Refer to https://www.linksys.com/us/support-article/?articleNum=135561 for additional support if using the Linksys Router or your router user’s manual.

1. Launch a web browser and enter “192.168.1.1” in the Address bar then press [Enter]. If the IP address does not work or if it has been changed, check the router’s IP address.

2. Enter the login credentials in the fields provided. The default password is admin. If the password was changed or personalized, use that instead. Note: these credentials are different from those to access Wi-Fi internet.

3. Click on the “Wireless” tab located under “Router Settings”.

4. Here, apply the following preset NEXUS Node Wi-Fi settings:
WiFi SSID: NEXLTS
WiFi Password: nexushub

Provided it is planned to use a dedicated router for NEXUS, it is recommended to configure the dedicated router to have the preset Wi-Fi SSID and WiFi as listed above.

As another option, an existing network with its own settings can be used to operate NEXUS. This would also be recommended for small deployments.

Step 608 may include designing, constructing, and/or assembling the robot platform (e.g., via NEXUS node). Entering into the hardware aspect of the build process, the next step is to construct the Robot Platform. NEXUS is platform agnostic, giving users the freedom to design or utilize any platform they desire.

The NEXUS Kit comes with a few robot design options made from COTS hardware with their own unique component usages. These pre-designed Robot Platforms can be referred to as NEXUS Example Robots. Users can still chose to build these according to design, or change the types of components used. For instance, NEXUS Example Robot 02 includes two servo motors which allow full control of the camera pan and tilt movements.

Items that may be used include:

| | |
|---|---|
| □ Rover Chassis | □ USB to USB-C Cable (length ≈3 inches) |
| □ NEXUS Node 01: | □ Servo Motor |
| • NEXUS Node Case with Raspberry Pi 4 Model B Single Board Computer (either 2 GB, 4 GB, or 8 GB models) | □ Servo Mount (U Type) |
| | □ USB Web Camera |
| • Flashed Micro SD Card - Section 3.1.3 | □ Zip Ties |
| • Pi Motor Shield Expansion Board | □ Electrical Tape (use as needed) |
| • I2C OLED Display | □ Velcro (length ≈ 6 inches) |
| • Female-Female Jumper Wires (qty. 4) | |
| □ 18650 Lithium-Ion Batteries (qty. 4 minimum) | □ Small Flat-head Screwdriver |
| □ 18650 Portable Power Bank | □ Phillips Head Screwdriver |
| □ 18656 Battery Storage Case (contains black and red wires) | □ (Optional) Breadboard |
| | □ (Helpful) Small Pliers |
| □ 18650 Battery Charger (eight cell count) | □ (Recommend) Wire Cutter |

1. Assemble the Rover Robot as instructed in the following video:

https://m.youtube.com/watch?v=OVHW_4qOuF4 (this can include installing the motors)

2. Install the web camera:

(a) Place the servo motor in the hole at the front of the chassis. Use screws from the servo mount to secure.

(b) Feed the wires through the back of the rover to the hole in the top.

(c) Attach the circular servo horn to the top of the servo motor’s output shaft, and screw the bottom of the U Type servo mount to the top of the servo horn.

(d) Secure the USB web camera onto the servo mount by using zip ties. Feed the cord through to the back of the rover, and store the excess cord in the front chassis.

3. Install other sensors to the platform, such as a temperature sensor, an Analog to Digital converter, or the like.

Attach NEXUS Node to Robot

1. Secure the NEXUS Node and power sources to the Rover Robot:

(a) Apply pieces of adhesive fastener (plastic hook side) in the following places on the Rover Robot:

Note: Use small 1 inch pieces, a little Velcro (adhesive fastener) goes a long way.
Top of the chassis on the rear side
Inside the chassis on the bottom frame on the rear side
Top of the NEXUS Node Case

(b) Apply the corresponding pieces of adhesive fastener (fuzzy loop side) on the following unattached items:
Bottom of the NEXUS Node Case
Bottom of the portable power bank
Bottom of the battery storage case

(c) Connect the following components to the Rover Robot:
Attach the NEXUS Node to the top of the chassis
Attach the portable power bank to the inside of the chassis
Attach the battery storage case to the top of the NEXUS Node Case

2. Configure the wires and cables:

(a) Connect the servo motor wire into the pins labeled “PWM/Servo” in slot 1 on the motor shield.

(b) Plug the camera cable into the USB port on the Raspberry Pi.

(c) Loosen the screws on the green terminal blocks labeled “M2, M1, M4, and M3”. Place the motor wires into this block and re-tighten the screws.

Note: The terminals listed above are in the order they appear on the motor shield.

(d) Loosen the screws on the blue terminal block labeled “5 V-12 V and GND”. Place the battery storage case wires into the panel and re-tighten the screws.

3. Secure and Tidy Cables:

(a) Use zip ties and electrical tape to secure and tidy the loose cables.

(b) Make sure cables aren’t pulled too tightly and creating tension at the connection point.

To turn on the Robot, NEXUS Node 01 can be connected to these power sources:
Plug the USB to USB-C cord from the portable power bank to the Raspberry Pi (to power the Pi)
Switch “on” the battery storage case (to power the motor shield)

When the robot is fully powered, the servo motors can react and the OLED can display the Raspberry Pi’s IP address. Note: make sure the above battery cases have fully charged batteries in them.

Step 612 may include setting up the command station. For example, the user can engage with a NEXUS Graphical User Interface (GUI) to manually control the Robot Platform, as well as engage in the software aspects of building the robot.

Items that may be used include:

| | |
|---|---|
| □ NEXUS Node 02: | □ Keyboard |
| • NEXUS Node Case with Raspberry Pi4 Model B Single Board Computer (either 2 GB, 4 GB, or 8 GB models) | □ Mouse |
| | □ Portable Monitor: |
| • Flashed Micro SD card - Section 3.1.3 | • USB-C Power Cable |
| • [Optional] Pi Motor Shield Expansion Board | • Power Adapter |
| • [Optional] I2C OLED Display | □ HDMI to Mini-HDMI Adapter |
| • [Optional] Female-Female Micro Jumper Wires (qty. 4) | □ Wireless Game Controller with USB Receiver (Pi compatible) |
| □ (Raspberry Pi Power Cable with Power Adapter | □ [Optional] Raspberry Pi In-line Power Switch |
| □ Micro-HDMI to HDMI Cable (for Pi 4) | □ [Optional] 25 ft. Power Cord Reel |

For assembling the command station hardware, the user may:

1. Organize the NEXUS Node, monitor, and power reel in the Command Station area.

2. Plug the power reel cord into a nearby outlet.

3. Connect the monitor power cable (white-green) and the Raspberry Pi power cable (white-orange) to the reel. White side of the cable plugs into the reel.

4. Connect the Raspberry Pi power switch (orange-yellow) to the end of the power cable (white-orange), and plug the switch (USB-C side) in the port labeled “POWER IN” on the Raspberry Pi.

5. Plug the monitor cord (white-green) into the USB-C port on the monitor.

6. Connect the HDMI to mini HDMI adapter (blue-green) to the HDMI to micro-HDMI cable (blueyellow) and plug the adapter into the monitor.

7. Plug the other end (yellow: micro-HDMI) of the cable into the “0 “HDMI” port on the Raspberry Pi.

8. Connect the mouse to the keyboard (pink cables), and plug the keyboard into a USB port on NEXUS Node 02.

The controller may be connected to the NEXUS Node 02 (e.g., wireless, wired, etc.).

Step 620 may include building one or more robot project files, such as by configuring the NEXUS software.

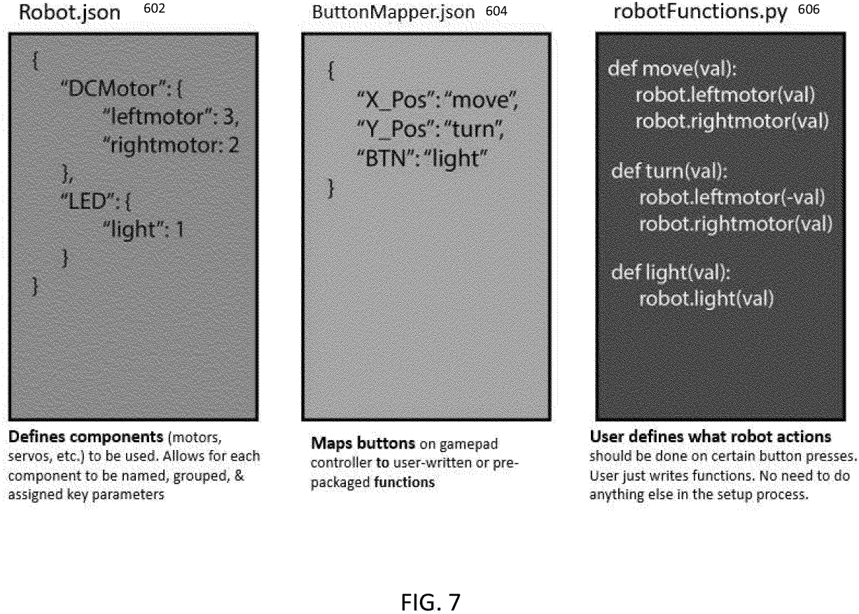

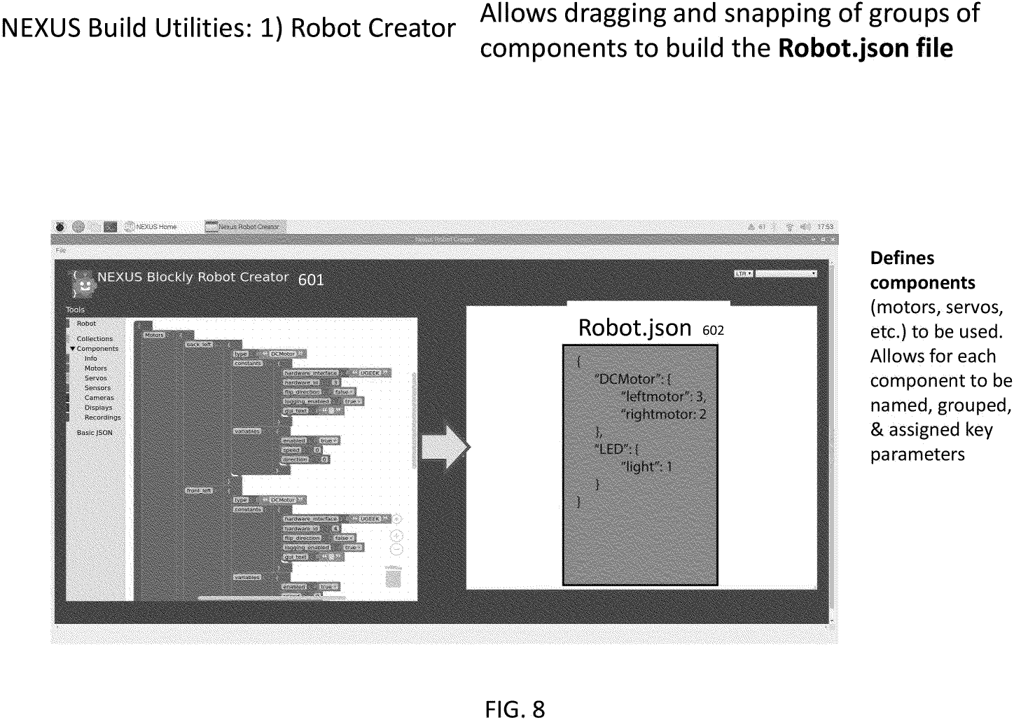

FIG. 7 illustrates a schematic diagram of three programmable files for control of the NEXUS system 100. The first file 602 (Robot.json) allows a user to define components (motors, servos, etc.) to be used and how. For example, file 602 allows for each component to be named, grouped, and/or assigned key parameters. The second file 604 (Buttonmapper.json) may be used to map interactive input elements (e.g., buttons, joystick, or the like) on the input devices (e.g., gamepad controller) to user-written or pre-packaged functions. The third file 606 (robotFunctions.py) may be used to define what robot actions should be done on certain button presses, which can be functions written or inputted by a user.

To construct the software side of the robot, the three project files have to be built and then programmed to the robot: robot.json, buttonmapper.json, and robotfunctions.py, which may provide for building the files using the Robot Creator, Button Mapper, and Function Editor applications respectively from a NEXUS Graphical User Interface (GUI), such as shown in figures referenced herein throughout, such as in FIG. 15.

FIG. 8 illustrates a schematic diagram for building file 602 in accordance with disclosed aspects. Programming file 602 allows for each component to be named, grouped, and/or assigned key parameters. Components are the building blocks for constructing robot files. The NEXUS components are organized into, for example, seven general groupings as follows:
Info: The information component allows the addition of metadata to the robot such as the robot name, the version name, and additional user comments.
Motors: Motors are devices that take electrical energy and convert it into physical movements. DC Motors allow the robotic platform to transport itself and other foreign objects to accessible locations. These can be attached to various wheels or propellers to transport the robot over land or through water or air.
Servos: Servos are devices that leverage DC Motors to provide controlled angles of motion. Servos allow the USB camera to rotate in different cardinal directions.
Sensors: Sensors are devices used to detect or measure a physical property and indicate or record it. There are multiple different types of sensors provided in the Adeept Sensor Kit that the user can choose to test and utilize.
Cameras: Cameras are devices used for recording visual images in the form of photographs, film, or video signals. The USB camera allows the user to record photographs and videos while operating the robotic platform.
Displays: Displays are electronic devices that visually present messages or data. The OLED display shows the IP address of the Raspberry Pi computer and the name of the robot if programmed by the user.
Recordings: Recordings and loggers can allow the user to make full usage of the sensors provided. Data that the user gathers as well as photos and videos can be saved into the files of the robot.

The following chart describes components and corresponding interactions.

| | | |
|---|---|---|
| Component | Provides | Interaction Methods |
| DC motor | rotation of robotic platform wheels | enable |
| | | direction (e.g., CW/CCW) |
| | | speed (e.g., 0 to 100%) |
| Servo motor | angle control for camera mounts | enable |
| | | min angle (integer value in degrees, e.g., 10) |
| | | max angle (integer value in degrees, e.g., 90) |
| | | angle (integer value in degrees, e.g., 50) |
| | | increment stepsize (integer value in degrees, e.g., 5) |
| | | increment |
| | | decrement |
| Analog sensors | measurements of environment via voltage levels | enable |
| | | voltage (value of the voltage measurement for sensor) |
| Camera | visual feedback (video and images) of robot surroundings | enable |
| | | video stream on /off |
| OLED display | text to be displayed to the operator (used for robot name and IP address) | enable |
| | | text (set text to display) |

With respect to NEXUS, each component can have a unique name to be distinguished in the software from other components. The component names are more generalized in the table above, but these reference names can be more specific when there are duplicate types. The user can have complete freedom in naming the components, however it is recommended to be intuitive and straightforward about naming conventions.

Though this primer presents the full set up of an example robot with basic components, there are many other component options that can be utilized to allow the robot to execute other functions. For example, there is a type of wheel that can allow a robot with four wheels to also move in a sideways direction, making it an omni-directional robot (see Appendix A.3). Other component options include but are not limited to: two servo motors (for full control of camera view), camera filters (night vision, red lens, etc.), LEDs (as a marker or flashlight), propellers (for water or air movements), or even robotic arms.

Core Functions: Existing functions defined within the NEXUS software that serve as helper functions to allow the robot programmer to update and control robot actions and readily send commands to a robot node in a simple, compact, and structured way. These functions include:
robot.update(): send commands to update the state of the robot’s components,
robot.do(): Causes the robot to execute the changes made to the robot’s state by the update commands.

The following example (Code 2.2) shows an annotated NEXUS robotfunctions.py script with custom user functions that can control the robot platform. Here, a user has created two functions named ‘move’ and ‘turn’. The ‘move’ function is defined for each possible value passed in from the controller (i.e., 0, 128, or 255). For each controller value, a block of code is created for each individual component that might be needed for a change in state to perform the intended command. The robot.update() function sets values for robot state parameters to be later executed. Then, the robot.do() function tells the robot to execute all staged robot state parameters previously set by robot.update() code lines. The ‘pass’ statement under the ‘turn’ function is a placeholder argument that is necessary to not break the script when a function is undefined. Once the user starts to program the ‘turn’ function this argument can be replaced with similar code seen in the ‘move’ function.

Code 2.2: NEXUS User De

| | |
|---|---|
| 1 | # Define custom robot functions here. |
| 2 | # Robot function activated by user input |
| 3 | def move(robot=None, gui=None, value=0): # this is the robot”, “gui”, and “value”. |
| 4 | speed = 70 # this is a variable called “sp |
| 5 | if value == 0: # this is the syntax for an ‘if’ the input variable “ value ”. |
| 6 | robot.update( collection=” Motors”, component=^{:} |
| 7 | robot.update( collection=” Motors”, component=^{:} |
| 8 | robot.update( collection=”Motors”, component=^{:} |
| 9 | robot.update( collection= “Motors”, component=^{:} |
| 10 | robot.do() # robot.update is written 4 time |
| 11 | # the command for this button value is to move |
| 12 | elif value == 128: |
| 13 | robot.update(collection=”Motors”, component=^{:} |
| 14 | robot.update(collection=”Motors”, component=^{:} |
| 15 | robot.update(collection=”Motors”, component=^{:} |
| 16 | robot.update(collection=”Motors”, component=^{:} |
| 17 | robot.do() # the command for this button |
| 18 | elif value == 255: |

Defined Functions Example
; the syntax to create a function called “move” with inputs “
“ speed ” with a value of 70.
‘ if ’ statement utilizing values from the game controller as
it=”back_left”, action=” forward”, parameters=[speed])
it=” front_left”, action=” forward”, parameters=[speed])
it=” back_right”, action=” forward”,parameters=[speed])
it=”front_right”, action=”forward”, parameters=[speed])
times, one for each DC motor on the robot platform.
ovethe robot forward (the action).
it=”back_left”, action=” stop”)
it=”front_left”, action=”stop”)
it=”back_right”, action=”stop”)
it=”front_right”, action=”stop”)
on value is to stop the robot (the action).

| | |
|---|---|
| 19 | robot.update( collection=”Motors”, component= |
| 20 | robot.update( collection=”Motors”, component= |
| 21 | robot.update( collection=” Motors”, component= |
| 22 | robot.update(collection=”Motors”, component= |
| 23 | robot.do() # the command for this button |
| 24 | # note the variable “ speed ” is specified once. throughout the “move” function. |
| 25 | |
| 26 | # Robot function activated by user input |
| 27 | def turn(robot=None, gui=None, value=0): # start of a |
| 28 | pass # placeholder syntax that allows the |

it=”back_left”, action=” backward”, parameters=[speed])
it=”front_left”, action=” backward”, parameters=[speed])
it=”back_right”, action=”,backward”, parameters=[speed])
it=”front_right”, action=” backward”, parameters=[speed])
on value is to move the robot backward (the action). nce, but utilized multiple times as the parameter argument
of a new function, notice the indentation structure. the script to run without breaking with undefinded functions.

According to some aspects, a user can use the NEXUS GUI 601 (Robot Creator) to drag and snap components to build the first file 602 (Robot.json). NEXUS GUI 601 allows dragging and snapping of groups of components to build the Robot.json file. In one example, a user can go to the NEXUS MainWindow and navigate to the “Build” tab. The user can click “Create Robot,” and save it to a new folder under “UserRobots.” The user can click “Robot Builder” and to create a .json file (e.g., file 602).

Robot Creator: robot.json:

The first project file can be the robot.json file. It is created using the Robot Creator application within the NEXUS GUI. Robot Creator can be constructed on Blockly, which is a library from Google for building beginner-friendly block-based programming languages. The robot.json file is the digital structure of the robot with all its physical components as well as the digital components. A Robot Creator GUI can use a visual block design that mimics the nested structure of the .json code to digitally construct the robot.

Follow the steps below to create the robot.json project file:

1. Under the “Build” tab, click on “Robot Creator”.

(note: to begin there can be a blank split screen with a gridded workspace and tool bar of tabs on the left side of the screen, and a blank white page on the right side of the screen. The gridded workspace is where the user can be digitally constructing the robot.)

2. Click on the red Robot Tab, then grab and insert the bracket into the workspace.

(note: The red Robot bracket may already be in the workspace and pre-populated with the Info and Display components. Ignore these components for now.)

3. Click on the Collections Tab, and insert it into the robot bracket. Rename the inserted bracket to “Motors”.

(hint: line the top of the bracket with an internal bracket connection inside the robot block. Though the user has the freedom to set the names, it is recommended to rename these “Collections” brackets using the same format as the Components tabs on the tool bar.)

(a) Expand the Components Tab and click on the one called “Motors”.

(b) Click and drag this bracket into the “Motors” Collection block (by lining up the two tabs).

(c) Rename the motor component to one of the DC Motors on the robot. (tip: when renaming do NOT put a space between words, instead use an underscore, dash, or camelcase, i.e.,“back_right”, “back-right”, “backRight”.)

(d) Correspond the “hardware id” with the terminal block numbers on the motor shield. For example, the back right motor is in terminal block 1 and the front right is in terminal block 2.
Do not change anything else.
One other constant that can be changed is the “gui text”.

(note: this can display the written text on the Robot’s Command Window while the user is connected to the Robot.)

(e) Repeat step 3b-d, for the rest of the motors that are physically on the Robot.

(note: the NEXUS Example Robot 01 should have four individually defined motor blocks.)

Using the same procedure as above with the DC Motor components, add the rest of the components with the following steps. Note, all collections of components are listed here but some can be used based the hardware that was put on the Robot Platform.

4. Insert another Collection block into the robot bracket, rename it to “Servos”.

(a) Insert and rename a servo component block.

(b) Correspond the “hardware id” with the pin numbers on the motor shield.

(c) Set the desired moving range as follows:
home: 50,
minimum (min): 10,
maximum (max): 90,
angle: 50.

(note: this can be customized, however, caution is advised in choosing the range. There is a limit to the servo’s range, above is the max range for the side to side panning direction. For the vertical tilting direction, it is recommended for the max to be 70 and the min to be 20.)

(d) In the “gui text” block write “Camera Angle: @angle”.

(note: this can display the angle of the camera on the Robot’s Command Window while the user is connected to the Robot Platform.)

(e) Repeat step 4a-d for the rest of the servo motors on the Robot.

(note: the Example Robots have at most two servo motors; one to pan and one to tilt the camera.)

5. Insert a Collection block into the robot bracket and rename it to “Cameras”.

(a) Insert and rename a camera component.

6. Insert a Collection block into the robot bracket and rename it to “Displays” (if not already there).

(a) Insert and rename a display component.

(note: this is the OLED. If decided to not include an OLED, skip this step.)

7. Insert a Collection block into the robot bracket and rename it to “Info” (if not already there).

(a) Insert an info component block.

(b) Write the name of the robot in the “robot name” block (it can be shown on the OLED display when the robot is programmed).

8. Insert a Collection block into the robot bracket and rename it to “Sensors”.

(note: Temperature, pressure, etc. sensors can be added here.)

(a) Insert and rename the sensor components for each sensor on the robot.

(b) Correspond the “hardware id” to the pin number on the Analog to Digital Converter.
The sensor converter can be specified in the robotfunctions.py file.

9. Insert a Collection block into the robot bracket and rename it to “Recordings”.

(a) Insert and rename each of the three different recording component blocks.

10. Click File then Save to save both the workspace (.xml) and the robot file (.json) to the robot project folder.

FIG. 6.3 simplifies and summarizes the above process, look for the Robot Creator icon.

According to some aspects, the user can grab the red robot bracket. The user can insert a collection block into the bracket and rename it to “Motors”. The user can insert and rename the motor components for each DC Motor on the robot. The user can correspond/relate the hardware ID with the terminal block numbers on the motor shield. For example, the back right motor is in the terminal block 1 and the front right is in terminal block 2.

The user can insert a collection block into the bracket and rename it to “Servos”. The user can insert and rename the servo components for each servo on the robot. The user can correspond/relate the hardware id with the pin numbers on the motor shield. The user can customize how far the user would like the servo to move. For example, the user can set the home constant to 50, the minimum constant to 10, the maximum constant to 90, the division constant to 20, and the angle variable to 50.

The user can insert a collection block into the bracket and rename it to “Sensors.” The user can insert and rename the sensor components for each sensor on the robot. The user can correspond/relate the hardware id to the pin number on the Analog to Digital Converter. The user can insert a collection block into the bracket and rename it to “Cameras”. The user can insert and rename one camera component. The user can insert a collection block into the bracket and rename it to “Displays”. The user can insert and rename one display component. The user can insert a collection block into the bracket and rename it to “Recordings”. The user can insert and rename each of the three different recording blocks. The user can save both the workspace (.xml) and the robot file (.json) to a robot folder.

A user can use the NEXUS GUI 601 (Robot Creator) to drag and snap components to build the Robot.json file 602. NEXUS GUI 601 allows dragging and snapping of groups of components to build the Robot.json file. In one example, a user can go to the NEXUS MainWindow and navigate to a “Build” tab.

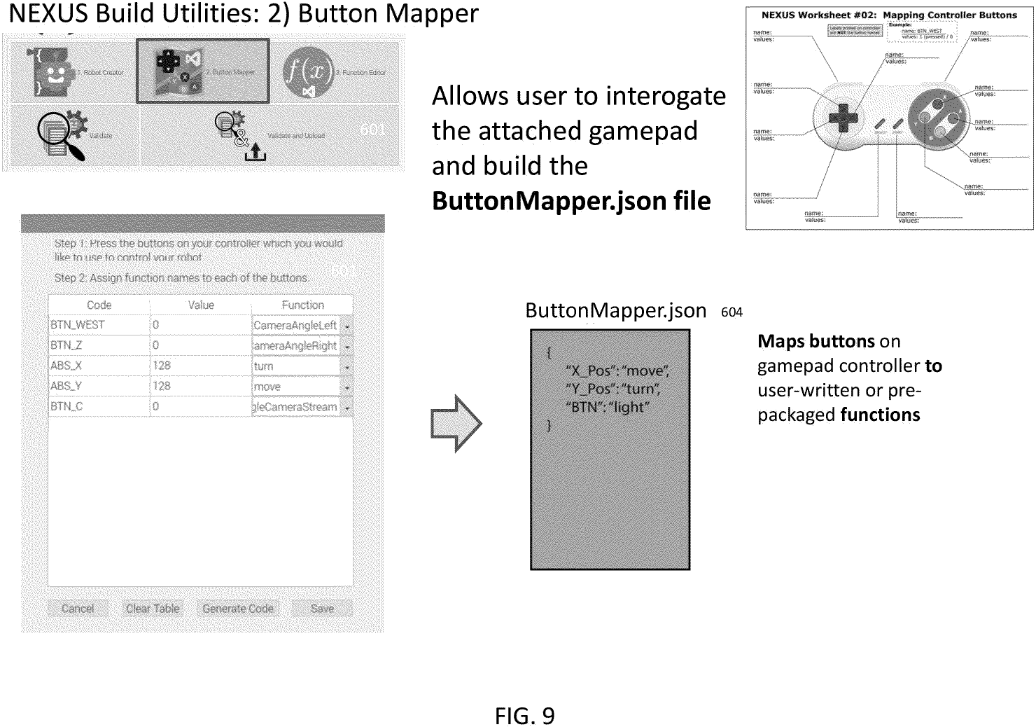

A user can use the NEXUS GUI 601 to interrogate buttons and button values of the attached gamepad and build the second file 604 (Buttonmapper.json), such as shown in FIG. 9. In addition, to inspecting the buttons and button values, NEXUS GUI 601 allows the user to associate a function name to each button to be incorporated into the Buttonmapper.json file which corresponds to code defined in the robotfunctions.py file. In one example, a user can go to the NEXUS MainWindow and navigate to the “Button Mapper” tab. The user can click “Button Mapper.” The user can turn on the wireless USB game controller and tap the buttons that the user would like to use to control the robot. The user can click “Generate Code” and then “Save.”

The second project file may be the buttonmapper.json file. It is created using the Button Mapper application within the NEXUS GUI. The buttonmapper.json file designates (or “maps”) the user’s desired robot commands to the wireless game controller, and creates the functions to be coded in the robotfunctions.py file.

Before jumping into the Button Mapper, there are a few quirks that must be discussed. First, the buttons on the game controller have uniquely programmed (or “hard coded”) names, and can be different than what is printed on the controller itself. This is something the user cannot change, and varies on the type of game controller. Second, each button has a hard coded value associated with its physical state (pressed or not pressed). Typically each button has two possible states, but there are a few that can have more. The button names and their possible values can be used to build the remaining project files.

Follow the steps below to create the buttonmapper.json project file and think about the possible functions and commands:

1. Go back to the “Build” tab in the NEXUS Main Window and click the “Button Mapper”.

2. Turn on the wireless USB game controller (press the “start” button).

3. Tap the buttons on the controller and observe what appears on the screen.
Complete NEXUS Worksheet 02 to record the hard coded button names and their possible values.

(hint: Press all the buttons one at a time and write down what appears.)
Complete NEXUS Worksheet 03 to name and plan the placement of the desired functions to the controller with the appropriate button values.

(hints: The D-pad is considered two buttons instead of four with this particular game controller. Functions are created from component actions and/or their combinations.
Most of the robot functions can apply to the DC or servo motors. However, the camera has the ability to turn off and on (or “toggle”) its video feed and could also be assigned to a button.

4. Assign function names to each of the buttons desired to control the robot in the Button Mapper window by typing them in the respective “Function” boxes.

(note: not all buttons might be used. Also spaces are not allow within function names.)

5. Once all desired functions are mapped to the buttons, click File, and then “Generate Code”.

6. Click the “X” in the top right corner to close the window.

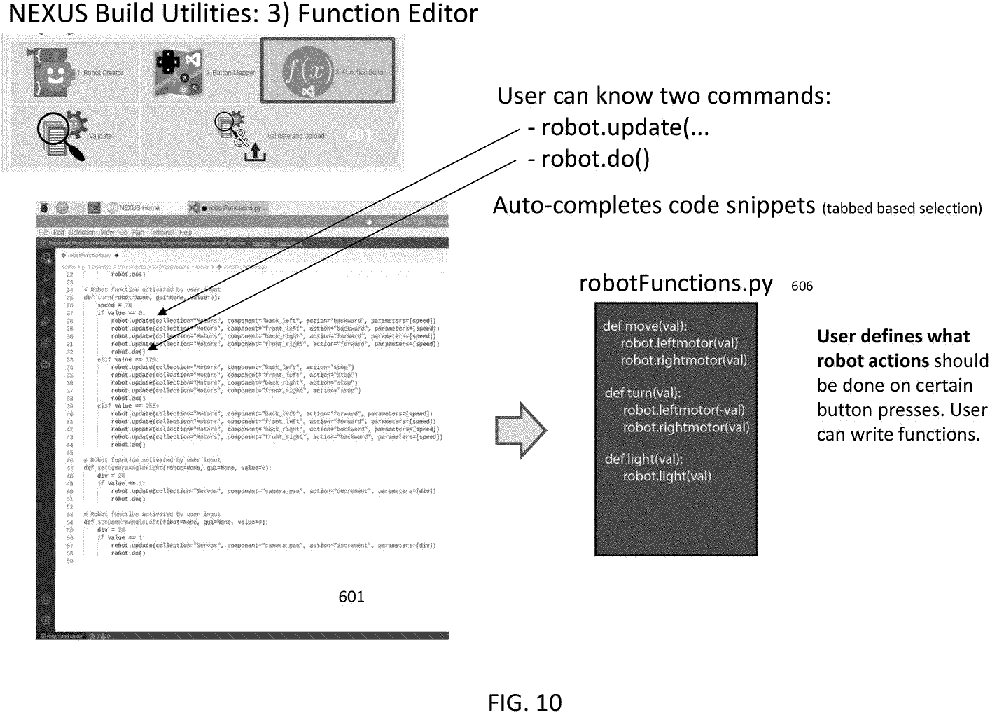

According to some aspects, the user can assign function names to each of the buttons, such as described in the following example for creating the third file 606 (UserFunctions.py), such as shown in FIG. 10.

Function Editor: robotfunctions.py

The third software project file can be the robotfunctions.py file. It is created using the Microsoft Visual Studio (VS) Code Function Editor within the NEXUS GUI. The robotfunctions.py file is the programming file that tells the robot what to do and how to operate a desired function when the button is pressed (or not pressed). Essentially, the robotfunctions.py can program the robot’s functions as designated in the Button Mapper, and their desired commands for the robot to execute.

There are a few ways to go about coding the robot’s functions. Users can have the freedom to name the functions whatever they desire and do not have to use the function names provided in the examples included in this primer. Follow the steps below to create the robotfunctions.py project file:

1. Go back to the “Build” tab in the NEXUS Main Window and click the “Function Editor”.

(note: the VS Code window can open with the function names that were predefined in the Button Mapper.)

The example function to define is called “move”. With this function it is expected for the robot to move forward, move backwards, or not move at all. These are the robot’s commands associated with this function, and are each designated to a button value. Therefore, this example assigned the function to the controller’s D-pad. In order for the robot to execute this function, the actions for each DC motor can be coded for each robot command. Remember, DC motors have three possible actions: “forward”, “stop”, and “backwards.”

2. Locate the code for the “move” function within the script.

3. Delete “pass” and replace it with “speed = 70”.

(note: this a percentage, therefore the DC Motors can be made up to 100 or as fast or slow as desired. Above is a good recommendation for control.)

4. Start a new line with a single indent and type “if value == 0:”.

(note: the values from the button mapper are now being defined, refer to worksheet 03. In this example, this is the up button on the D-pad and associates with the robot’s “move forward” command. If using a binary state button, the code can start with “if value == 1:”.)

5. Click the Enter key, the newline should indent once more.

6. Start typing “robot.update”

(note: an auto-complete of options should appear with the “collection”, and “component” options filled in.)

7. Select a component (any DC Motor put in the robot.json file) in the “Motors” collection.

(note: the collection should now read “Motors”, and the component should be a user defined motor name.)

8. Select the desired action of that specific motor (in this first case the “forward” motor action).

9. Define the parameter as “speed” (since the motor is moving).

(note: idle movements might not need parameters)

10. Make sure the cursor is outside of the parenthesis at the end of the statement and press Enter.

11. Repeat Steps 6 - 10 for the remaining DC Motors on the robot.

(note: NEXUS Example Robot 01 should have 4 lines of code per button value by the end of this step.)

12. Type “robot.do()” (make sure this is on a new line).

13. Repeat Steps 3-13 for the “stop” (or “idle”) and “backward” actions with the appropriate values and the “elif command. (note: if the D-pad is designated for this function, the values 128 and 255 can begin with “elif value == 128:” or “elif value == 255:”.)
Note: for DC motor functions, the “idle” state may be defined to a button value. Otherwise the motors might not be told to stop after the button is pressed.

The “move” (or similar) function has been successfully defined for the robot, and should include the “forward”, “idle”, and “backward” robot commands (if assigned to the controller’s D-pad).

A new robotfunctions.py file has been created under the user’s Robot project folder!

According to some aspects, the user can go back to the “Build” tab in the NEXUS MainWindow and click the “Function Editor.” The user can delete “pass” and replace it with “speed = 100”. This a percentage, and therefore the user can make the DC Motors as fast or as slow as the user desires. The user can start a new line with a single indent and type “if value == 0:”. The user can click the Enter key the newline should indent once more. (note: The user is now defining the values from the button mapper. The values 128 and 255 on the D-Pad can begin with “elif value == 128:” or “elif value == 255:”). The user can start typing “robot.update” and see auto-complete options. The user can select the one that says “Motors”. The collection should now read “Motors” and the component should be any DC Motor that the user put in the .json file. There are three example predefined actions for motors: forward, backward, and stop. The user can select what the user wants that specific motor to perform, and since the motor is moving, its parameters must be defined as the speed. (note: idle movements might not need parameters). The user can repeat Steps 3 and 4 for all DC Motor components. The user can press the Enter key and type “robot.do()”. The user can repeat Steps 2-6 to define all the values on the game controller.

At this point in the primer, the three NEXUS robot project files have been built (or “coded”) using the Robot Creator, Button Mapper, and Function Editor. Currently, these project files reside on the Command Station. To complete the synergy between hardware and software, the files may be sent to the robot. Uploading the three project files “programs” the robot to be able to execute future commands by the user.

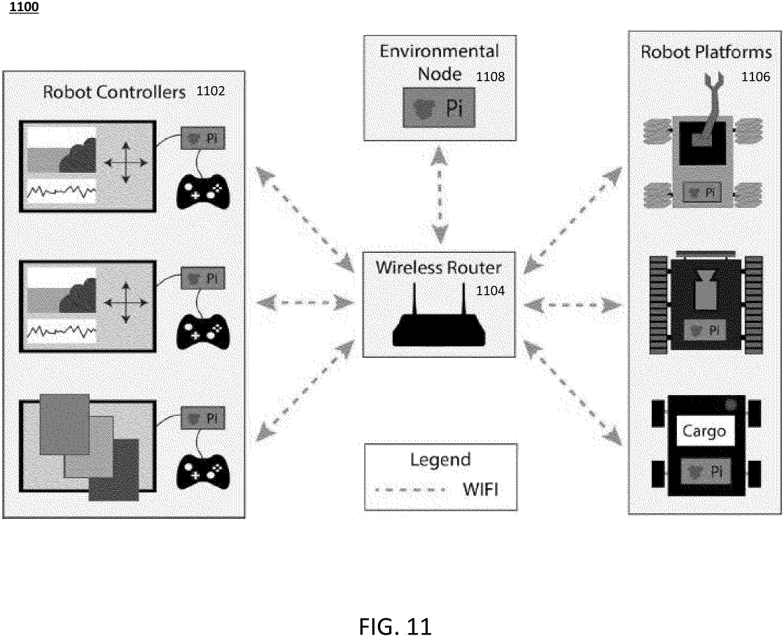

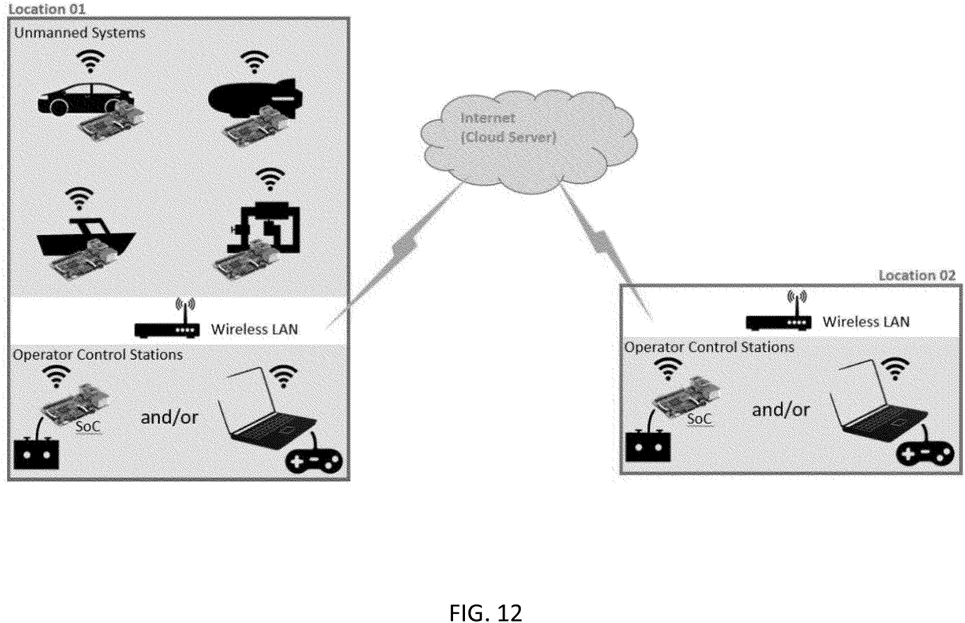

FIGS. 11 and 12 illustrate an example implementation of one or more disclosed embodiments, such as system 100. FIG. 11 shows a high level system 1100 of multiple robot controllers 1102 connected to a wireless router 1104 (which could be another routing/connection device). Router 1104 can be connected to robot platforms 1106 and/or environmental nodes 1108 (e.g., other devices described herein, such as with respect to FIG. 12). As shown, nodes (e.g., a PCD, such as a raspberry pi) may be included at each controller 1102, robot platform 1106, and environmental node 1108.

FIG. 12 shows an example schematic of the wireless modular framework (e.g., system 100) for controlling multiple unmanned systems onsite (Location 01) as well as from an offsite location (Location 02). As shown, a PCD (e.g., node 1 or node 2) in accordance with disclosed aspects may be implemented in a wide array of environmental nodes, unmanned systems, devices, and/or vehicles. These may include a car, underwater vehicle, above water vehicle, watercraft, digger, pump, thruster, mechanical arm, robotic arm, manipulator, or the like. According to some aspects, a first tier of the Wireless Framework Foundation may enable wireless control of unmanned systems over a local area network as a single location (e.g., Location 01). This may include hardware and software for operators to control unmanned systems remotely at a single location. This may include a node device for each unmanned system, wireless router, and second node for remote control as well as necessary software on each node to enable communications. A second tier may leverage Internet Connectivity to enable wireless operation from remote locations (e.g., Location 02) via connection to a cloud based server or the like. Users can program the control of each unmanned system, allow for sensor payloads and can implement autonomous operation of multiple unmanned systems.

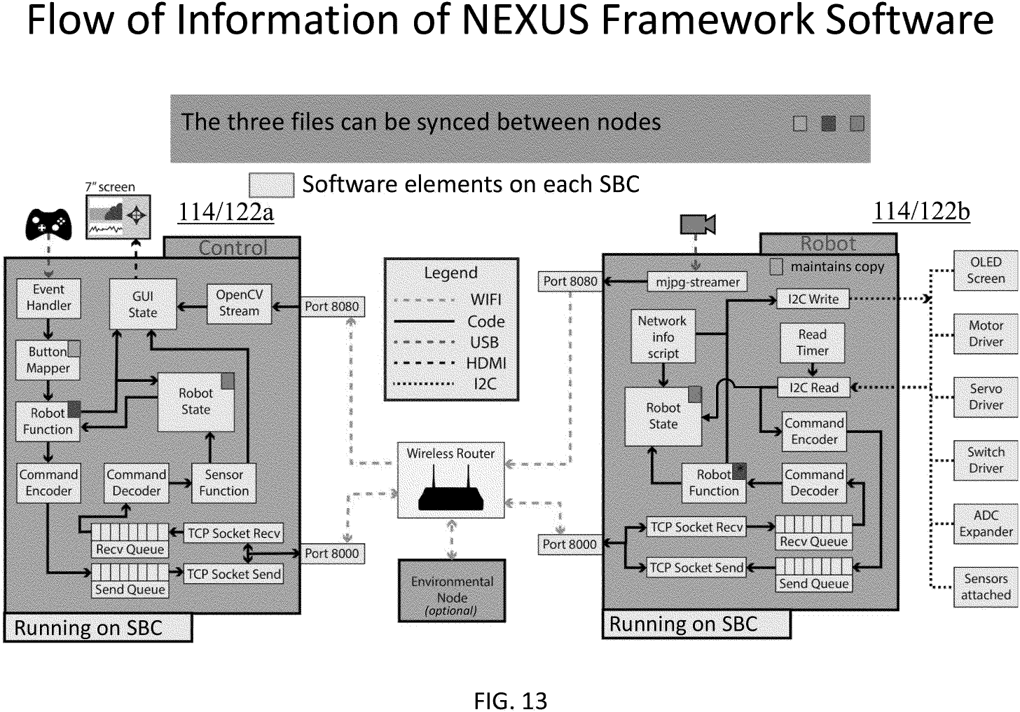

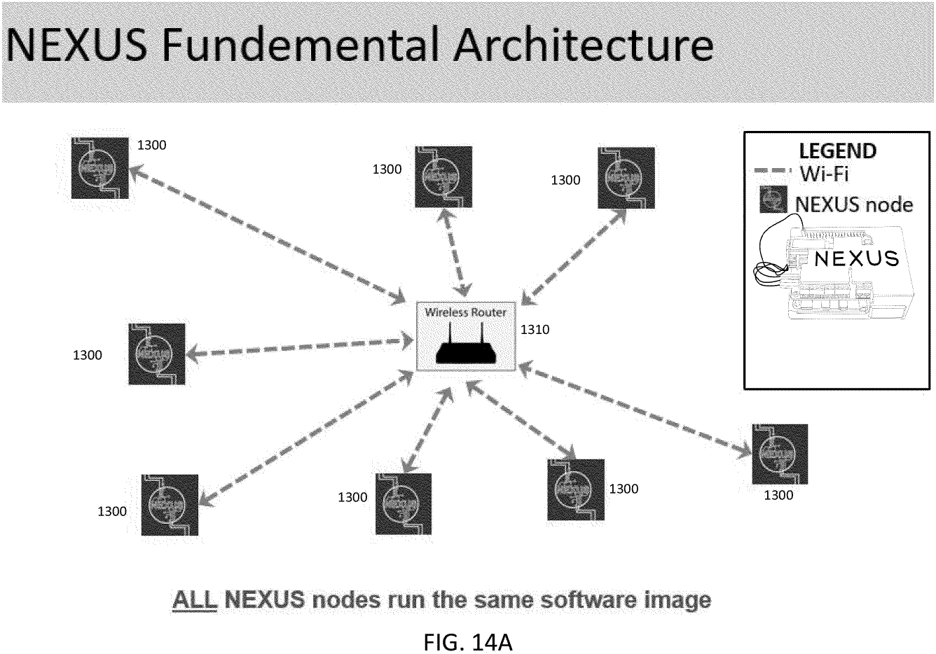

FIG. 13 is a flow schematic block diagram of NEXUS which illustrates the communication of one or more software elements of a NEXUS node as well as interconnections between the two NEXUS nodes. NEXUS nodes 114/122 can be run as a control or a robot node based on connected hardware components and/or user interaction. FIG. 13 shows left NEXUS node 114/122a running as a control node and the right NEXUS node 114/122b as a robot node with interconnection via wireless router. On the NEXUS control node, the user interacts with the gamepad/controller. Signal information from the gamepad is sent to the Event Handler software element, and decoded using the Button Mapper software element via a buttonmapper.json configuration file. Next, the information is passed to the Robot Function element which interprets the command via user defined operations denoted in a robotfunctions.py file. In addition, the Robot Functions software element ingests robot state information based on a robot.json file. The Robot State block is initialized on both nodes simultaneously using a robot.json file. The Robot State block is dynamically updated through code from a robotfunctions.py file as well as through the automatic reading of sensor values on the side of the robot node. If the robot state is ever updated on the node (either robot or control), a message is sent to the other node (either control or robot) to update its state, and therefore both nodes (control and robot) are kept in sync. The camera is accessed by an open source stream server called mjpg-streamer. The stream can be accessed by any device on the network via a url. The state of the robot along with the camera stream is displayed on the monitor (connected to the control node) through the NEXUS control GUI. State updates on the robot node are pushed via I2C interface to the physical hardware components. The environmental node allows for a set of configurations that can impose artificial constraints on functionality of any connected robot(s) as well as data streams between control and robot nodes (e.g., adding a delay between gamepad button press and robot behavior to simulate real-world command and control signal lag). For example, to mimic what happens on Mars, a lag may be placed on the network associated with the network device connected to one or more NEXUS nodes. The lag may, for example, implement a 7 minute delay between communication between nodes or other components. This may be a latent effect in feedback or instructions sent on the network. The environmental node may provide additional information on the network to reduce bandwidth to implement this lag, which may reduce the number of information packets successfully transmitted. The environmental node may do this through a global control or implementation on one or more devices operation on such a network. Such implementation may include a sample rate limit, a maximum frame rate (e.g., for a camera), or the like.

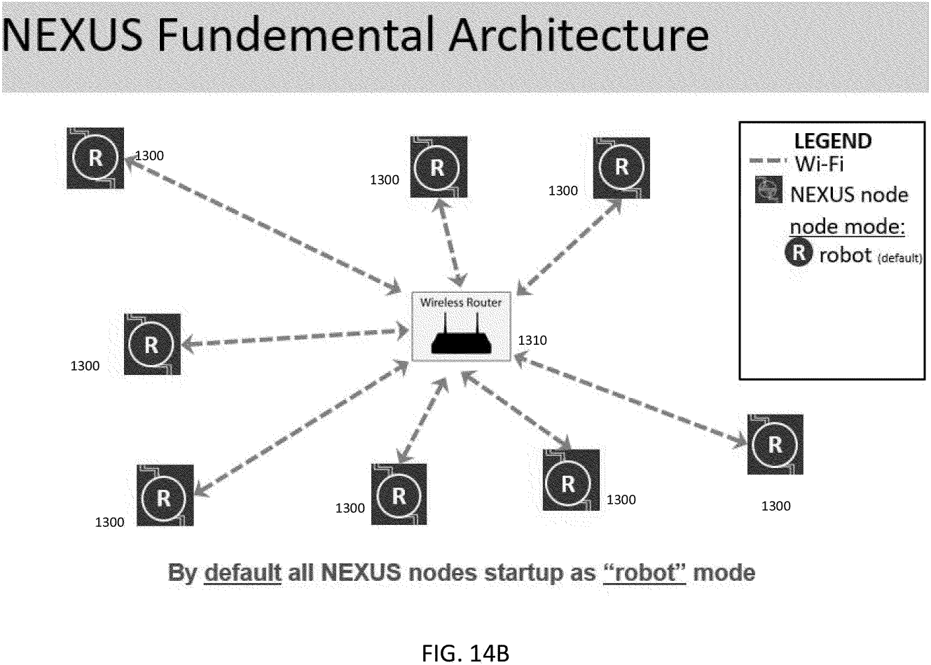

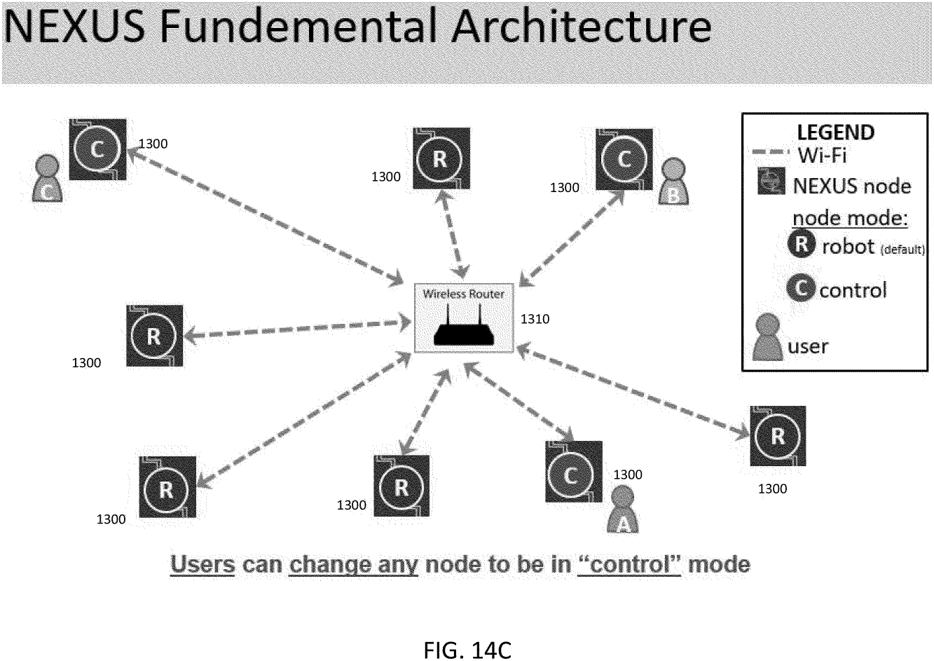

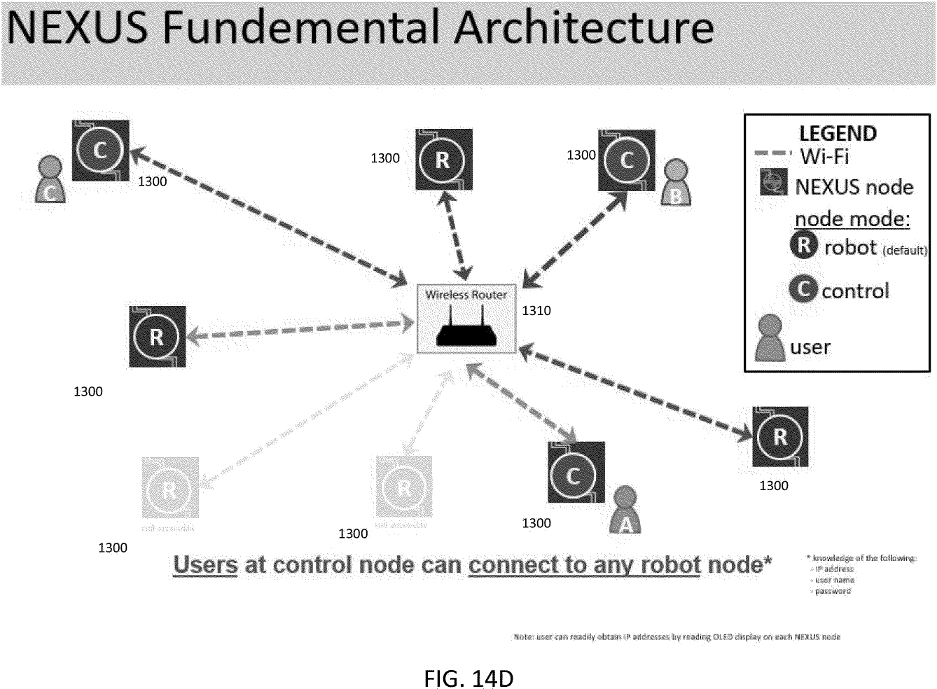

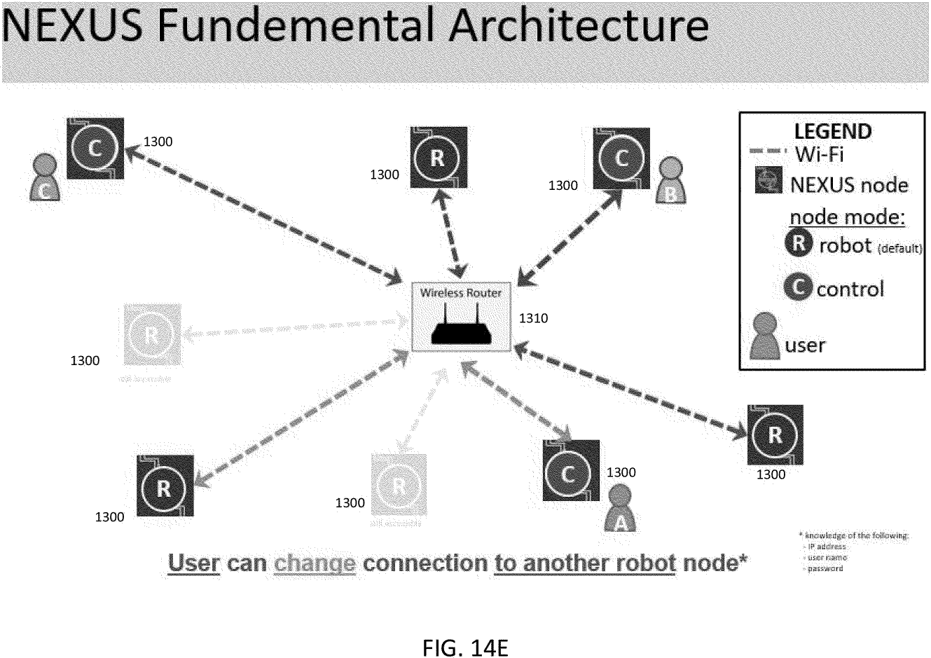

FIGS. 14A-E illustrate NEXUS architecture examples in accordance with disclosed aspects. For example, a plurality of nexus nodes 1300 may be connected to a wireless router 1310 (e.g., such as described herein). As shown in the example NEXUS architecture, nodes 1300 may be connected (e.g., via Wi-Fi) to a router 1310, which may be a wireless router. In some embodiments, all of the nodes 1300 may run the same software image. The wireless router 1310 can be connected to the internet (or some other network), and NEXUS nodes 1300 might be located in different locations, such using the internet to remote in to nodes 1300. In some embodiments, the router 1310 might not be connected to the internet, but can still connect to the nodes 1300, which may be for deployment in remote locations with limited internet, for example.

FIG. 14A shows an example where all of the nodes 1300 run the same software image. FIG. 14B shows an example where each node 1300 starts up in robot mode. FIG. 14C shows an example where a user can change any of the nodes 1300 to be in control mode. FIG. 14D shows an example where user at a control node can connect to any robot node. FIG. 14E shows an example where a user can change connection to another robot node. According to disclosed aspects, a user may use the IP address, user name, and/or password associated with a node 1400 for connecting to and/or changing to a corresponding node 1300.

Specifically, disclosed embodiments may include three main package types: communication, sensor handling, and control. Disclosed embodiments may be used to link a given unmanned system to another unmanned system or an operator control station over a LAN or internet connection. Sensor handling packages may receive, process, and publish sensor data (e.g., camera feeds, depth data, and temperature data) to the current system and to other network connect devices. The control packages may leverage both the communication and sensor handling packages to translate messages into commands to control each unmanned system. Each package may have complete functional libraries as well placeholders for including customized code written by users.

The following are examples of code for the NEXUS system in accordance with disclosed aspects.

### 6.4 Rover Robot Example Project Files

Complete code for each of the three robot project files is included in this section.

Code 6.1: Rover Robot “robot.json” file

| | |
|---|---|
| 1 | { |
| 2 | ”Info”: { |
| 3 | ”robot_info”: { |
| 4 | ”type”: ”Robotinformation”, |
| 5 | ”constants”: { |
| 6 | ’’hardware_interface”: ’’InformationInterface”, |
| 7 | ’’robot_name”: ’’Rover”, |
| 8 | ’’logging_enabled”: false, |
| 9 | ’’gui_text”: ””, |
| 10 | ’’project-name”: ”Rover” |
| 11 | }, |
| 12 | ’’variables ”: { |
| 13 | ’’enabled”: true |
| 14 | } |
| 15 | } |
| 16 | }, |
| 17 | ’’Motors”: { |
| 18 | ’’back_left”: { |
| 19 | ’’type”: ’’DCMotor”, |
| 20 | ’’constants”: { |
| 21 | ’’hardware_interface”: ’’UGEEK”, |
| 22 | ’’hardware_id”: 4, |
| 23 | ’’flip_direction”: false, |
| 24 | ’’logging_enabled”: true, |
| 25 | ’’gui_text”: ’’’’ |
| 26 | }, |
| 27 | ’’variables”: { |
| 28 | ’’enabled”: true, |
| 29 | ’’speed”: 0, |
| 30 | ’’direction”: 0 |
| 31 | } |
| 32 | }, |
| 33 | ’’front_left”: { |
| 34 | ’’type”: ’’DCMotor”, |
| 35 | ’’constants”: { |
| 36 | ’’hardware_interface”: ’’UGEEK”, |
| 37 | ’’hardware_id”: 3, |
| 38 | ’’flip_direction”: false, |
| 39 | ’’logging_enabled”: true, |
| 40 | ’’gui_text”: ’’’’ |
| 41 | }, |
| 42 | ’’variables”: { |
| 43 | ’’enabled”: true, |
| 44 | ’’speed”: 0, |
| 45 | ’’direction”: 0 |
| 46 | } |
| 47 | }, |
| 48 | ’’back_right”: { |
| 49 | ’’type”: ’’DCMotor”, |
| 50 | ’’constants”: { |
| 51 | ’’hardware_interface”: ’’UGEEK”, |
| 52 | ’’hardware_id”: 1, |
| 53 | ’’flip_direction”: false, |
| 54 | ’’logging_enabled”: true, |
| 55 | ’’gui_text”: ’’’’ |
| 56 | }, |
| 57 | ’’variables”: { |
| 58 | ’’enabled”: true, |
| 59 | ’’speed”: 0, |
| 60 | ’’direction”: 0 |
| 61 | } |
| 62 | }, |
| 63 | ’’front-right”: { |
| 64 | ’’type”: ’’DCMotor”, |
| 65 | ’’constants”: { |
| 66 | ’’hardware_interface”: ’’UGEEK”, |
| 67 | ’’hardware_id”: 2, |
| 68 | ’’flip_direction”: false, |
| 69 | ’’logging_enabled”: true, |
| 70 | ’’gui_text”: ’’’’ |
| 71 | }, |
| 72 | ’’variables”: { |
| 73 | ’’enabled”: true, |
| 74 | ’’speed”: 0, |
| 75 | ’’direction”: 0 |
| 76 | } |
| 77 | } |
| 78 | }, |
| 79 | ’’Servos”: { |
| 80 | ’’camera_pan”: { |
| 81 | ’’type”: ’’Servo”, |
| 82 | ’’constants”: { |
| 83 | ’’hardware_interface”: ’’UGEEK”, |
| 84 | ’’hardware_id”: 1, |
| 85 | ’’home”: 50, |
| 86 | ’’min”: 10, |
| 87 | ’’max”: 90, |
| 88 | ’’logging_enabled”: true, |
| 89 | ’’gui_text’’: ’’Camera Angle: @angle’’ |
| 90 | }, |
| 91 | ’’variables”: { |
| 92 | ’’enabled”: true, |
| 93 | ’’angle”: 50 |
| 94 | } |
| 95 | } |
| 96 | }, |
| 97 | ’’Cameras”: { |
| 98 | ’’front-cam”: { |
| 99 | ’’type”: ’’USBCamera”, |
| 100 | ’’constants”: { |
| 101 | ’’hardware_interface”: ’’MJPGStreamer”, |
| 102 | ’’resolution”: ’’640x480”, |
| 103 | ’’framerate”: 10, |
| 104 | ’’logging_enabled”: false, |
| 105 | ’’gui_text”: ’’’’ |
| 106 | }, |
| 107 | ’’variables”: { |
| 108 | ’’enabled”: true, |
| 109 | ’’is_streaming”: false |
| 110 | } |
| 111 | } |
| 112 | }, |
| 113 | ’’Displays″: { |
| 114 | ’’oled_mini”: { |
| 115 | ’’type”: ’’OLED-128x32”, |
| 116 | ’’constants”: { |
| 117 | ’’hardware_interface” : ’’OLED”, |
| 118 | ’’refresh_rate”:1, |
| 119 | ’’float_text_decimal_places”: 2, |
| 120 | ’’default_text”: ’’@core.robot_name\nIP: @core.robot_ip”, |
| 121 | ’’logging_enabled”: false, |
| 122 | ’’gui_text”: ’’’’ |
| 123 | }, |
| 124 | ’’variables′’: { |
| 125 | ’’enabled”: true, |
| 126 | ’’text”: ’’’’ |
| 127 | } |
| 128 | } |
| 129 | } |
| 130 | } |

Code 6.2: Rover Robot “buttonmapper.json” file

| | |
|---|---|
| 1 | { |
| 2 | ”ABS_X”: ”turn”, |
| 3 | ”ABS_Y”: ”move”, |
| 4 | ”BTN_TR2”: ”toggleCameraStream”, |
| 5 | ”BTN_NORTH”: ”panleft”, |
| 6 | ”BTN_EAST”: ”panright”, |
| 7 | ”BTN_TL2”: ”CameraHome” |
| 8 | } |

Code 6.3: Rover Robot “robotfunctions.py” file

| | |
|---|---|
| 1 | # Define custom robot functions here. |
| 2 | # Robot function activated by user input |
| 3 | def move(robot=None, gui=None, value=0): |
| 4 | speed = 70 |
| 5 | if value == 0: |

| | |
|---|---|
| 6 | robot.update(collection =”Motors”, component=” |
| 7 | robot.update(collection=”Motors”, component=” |
| 8 | robot.update(collection=”Motors”, component=” |
| 9 | robot.update(collection=”Motors”, component=” |
| 10 | robot.do() |
| 11 | elif value == 128: |
| 12 | robot.update(collection=”Motors”, component=” |
| 13 | robot.update(collection=”Motors”, component=” |
| 14 | robot.update(collection=”Motors”, component=” |
| 15 | robot.update(collection=”Motors”, component=” |
| 16 | robot.do() |
| 17 | elif value == 255: |
| 18 | robot.update(collection=”Motors”, component=” |
| 19 | robot.update(collection=”Motors”, component=” |
| 20 | robot.update(collection=”Motors”, component=” |
| 21 | robot.update(collection=”Motors”, component=” |
| 22 | robot.do() |

back_left”, action=”forward”, parameters=[speed])
front_left”, action=”forward”, parameters=[speed])
back_right”, action=”forward”, parameters=[speed])
front_right”,actions=”forward”, parameters=[speed])
back_left”, action=” stop”)
front_left”, action=”stop”)
back_right”, action=”stop”)
front_right”, action=”stop”)
back_left”, action=”backward”, parameters=[speed])
front_left”, action=”backward”, parameters=[speed])
back_right”, action=”backward”, parameters=speed])
front_right”, action=”backward”, parameters=[speed])

| | |
|---|---|
| 24 | #Robot function activated by user input |
| 25 | def turn(robot=None, gui=None, value=0): |
| 26 | speed = 70 |
| 27 | if value == 0: |
| 28 | robot.update(collection=” Motors”, component=” |
| 29 | robot.update(collection=”Motors”, component=” |
| 30 | robot.update(collection=”Motors”, component=” |
| 31 | robot.update(collection=”Motors”, component=” |
| 32 | robot.do() |
| 33 | elif value == 128: |
| 34 | robot.update(collection=”Motors”, component=” |
| 35 | robot.update(collection=”Motors”, component=” |
| 36 | robot.update(collection=”Motors”, component=” |
| 37 | robot.update(collection=”Motors”, component=” |
| 38 | robot.do() |
| 39 | elif value == 255: |
| 40 | robot.update(collection=”Motors”, component=” |
| 41 | robot.update(collection=”Motors”, component=” |
| 42 | robot.update(collection=”Motors”, component=” |
| 43 | robot.update(collection=”Motors”, component=” |
| 44 | robotdo() |

back_left”, action=”backward”, parameters=[speed])
front_left”, action=”backward”, parameters=[speed])
back_right”, action=”forward”, parameters=speed])
front_right”, action=”forward”, parameters=speed])
back_left”, action=”stop”)
front_left”, action=”stop”)
back_right”, action=”stop”)
front_right”, action=”stop”)
back_left”, action=”forward”, parameters=speed])
front_left”, action=”forward”, parameters=[speed])
back_right”, action=”backward”, parameters=[speed])
front_right”, action=”backward”, parameters= [speed])

| | |
|---|---|
| 45 | |
| 46 | # Robot function activated by user input |
| 47 | def toggleCameraStream(robot=None, gui=] |
| 48 | if value = = 1: |
| 49 | robot.update(collection=”Cameras” |
| 50 | robot.do () |
| None, value=0):, component=”front_cam”, action=”toggleStream”) | |
| 51 | |
| 52 | # Robot function activated by user input |
| 53 | def panright(robot=None, gui=None, value |
| 54 | div = 20 |
| 55 | if value == 1 : |
| 56 | robot.update(collection=”Servos”, |

=0); components=”camera_pan”, action=”decrement”, parameters=[div])

| | |
|---|---|
| 57 | robot.do() |
| 58 | |
| 59 | # Robot function activated by user input |
| 60 | def panleft (robot=None, gui=None, value=0): |
| 61 | div = 20 |
| 62 | if value == 1: |
| 63 | robot.update(collection =”Servos”, component |
| 64 | robot.do() |
| 65 | |
| 66 | def CameraHome(robot=None, gui=None, value=0): |
| 67 | if value == 1: |
| 68 | robot.update(collection”Servos”, component |
| 69 | robot.update(collection=”Servos”, component |
| 70 | robot.do() |

”camera_pan”, action=”increment”, parameters=[div])
”camera_pan”, action=”goHome” )
”camera_tilt”, action=”goHome″ )

Step 626 may include uploading the robot project build files to the robot platform.

### Upload NEXUS Robot Project Files to Robot Platform

In programming the robot, a user may obtain the robot’s IP address. The IP address should be revealed on the OLED display attached to NEXUS Node 01 on the Robot Platform. Turn on NEXUS Node 01 if the OLED display is not showing anything. If it was decided not to use an OLED, one may obtain the robot’s IP address via the computer terminal in some cases.

Since NEXUS is designed to engage users at various levels, there are a few options to program a NEXUS robot.

### Upload Existing Example Project Files

### Upload User-Built Project Files

Step 630 may include controlling the robot platform from the command station.

1. Turn on Node 01.

2. Turn on Node 02 and wait until the NEXUS desktop appears.

3. Click on the small blue “NEXUS” icon,

4. Once the NEXUS Main Window is opened, three separate tabs are seen:
Welcome to NEXUS
Build
Control

5. Navigate to the Control tab.

6. Enter the IP address of the robot, found via the OLED display or the terminal (in Appendix B.2).

7. Enter the robot’s user name and password as follows:
robot user name: pi
robot password: nexususer

8. Press the “START” button on the wireless USB game controller.

9. Click the “Connect to Robot” button.

The command center window should open with a video feed from the robot’s camera in the center.

10. Use the wireless game controller to operate the robot.

The user now has full control of the robot (step 630).

Disclosed aspects provide for a system that streamlines system integration of multiple COTS components. Disclosed aspects provide for a modular, standardized framework that can be implemented via controlling, monitoring, and/or modifying key state parameters.

Disclosed aspects provide for enabling rapid development and prototyping of platform agnostic robotic systems through streamlined system integration of multiple COTS hardware and modular & standardized command and control (C2).

Disclosed aspects provide for the ability to rapidly develop robotic systems with different platforms and sensors as well as implement command and control (C2). This may be useful for scientists, researchers, and engineers to support field and laboratory experiments over a broad range of applications as well as train future Unmanned System operators.

Disclosed aspects provide for a modular & standardized robotics framework to streamline system integration of multiple COTS components and enable command and control (C2).

Disclosed aspects provide for scalability to easily to add multiple components, new user-defined algorithms, and nodes to the system.

Disclosed aspects provide for a unified software, where one or more (or all) NEXUS nodes may run a common software image.

Disclosed aspects provide for provide for high-level commands through straightforward code functions and APIs to control the robotic systems.

Disclosed aspects provide for, in some embodiments, three key files for a user to program and control a robotic platform system: a robot definition file, a button mapping file (for controller), and a robot functions definition file.

Disclosed aspects provide for custom graphical user interfaces (GUIs) to aid in rapid graphical creation of the three key files and guide the user through all the build steps, code deployment, and system control.

One or more embodiments provide for a wireless modular framework for ease of controlling an ecosystem of unmanned systems which leverages economical, commercially available, off-the-shelf components, e.g., system on a chip (SoC) such as the Raspberry Pi, as control units for each unmanned system. The disclosed framework is platform agnostic, allowing STEM students and researchers to use a premade system or to use their imagination to build their systems out of material commonly available at craft, grocery, and/or hardware stores as well as even their own custom design parts using 3D printers or laser cutters. Furthermore, the framework allows users to write custom modular code snippets to control their unmanned systems leveraging Linux running the open source Robotic Operating System (ROS; http://www.ros.org/) for remote and/or autonomous control. In addition, the wireless framework allows sensor integration onto the unmanned system platforms such as cameras, distance sensors, light, and/or temperature detectors to enable real-time data feeds to support operational command decisions or autonomous guidance. The tightly coupled hardware-software integration provides critical feedback to the operator to improve their physical system design and/or software algorithm (through the Engineering Design Cycle). Furthermore, the wireless framework exposes users to the next generation of operational challenges with unmanned systems: coordination and communication across multiple unmanned systems distributed throughout a region to accomplish mission goals.

Some advantages that NEXUS provides over prior systems can include the use of simplified Python code functions and APIs, which can control the robot with high level commands. NEXUS allows a user to quickly customize and program a robotic platform system through the development of 3 key files: robot definition file, button mapping file for controller (e.g., gamepad), and robot functions definition file. While these files can be created using a standard text editor, NEXUS includes custom graphical user interfaces (GUIs) to aid in rapid graphical creation of the three key files and guide the user through all the build steps, code deployment, and system control.

NEXUS may include the following novel features:
Dynamic Button Mapper interface
Command Center real-time feedback and control
Standardized structure for Robot component building blocks
Ability to upload code that automatically runs on Robot node
Ability to collect data, store locally on Robot node for rapid collection, transfer between devices, and inspect data all via simple graphical user interfaces
Video stream setup is automatic and can be controlled by any computer which is programmed to talk the communication protocol
Standardized structure for adding different components (new hardware or software algorithms)

The NEXUS wireless framework is platform agnostic (marine, aerial, and/or land based robotic systems) and allows for engagement at multi-levels of user skill. At a basic user skill level, the framework can allow multiple users to each control unmanned vehicle platforms while simultaneously exposing users to communication challenges for manually operating and coordinating differently configured unmanned vehicle platforms to successfully complete a common mission. At intermediate user skill levels, users can design, develop, and deploy custom unmanned vehicle platforms out of material commonly available at craft, grocery, and hardware stores as well as creating custom designed parts using low-cost 3D printers and laser cutters which exposes users to the Engineering Design Cycle where they can use immediate feedback to improve their designs. At advanced skill levels, users can program each unmanned vehicle platforms to enable autonomous operation of an individual platform or the entire diverse group of unmanned platforms (i.e., swarm dynamics).invention is designed to synchronize the sampling of various spatially distributed instrumentation (in the field and/or in the laboratory).

Disclosed embodiments can leverage Raspberry Pi devices (a SoC that is readily available, low cost and has a wide developer community). Disclosed aspects can run on the Raspberry Pi to enable communication between operator controls and unmanned systems, such as to wirelessly control SeaPerch vehicles. NEXUS software can be written in Python and C++ contained in Robot Operating System (ROS) packages to enable both manual control of unmanned systems via standard controllers (e.g., SeaPerch controller or standard gamepad) as well as program based control to explore artificial intelligence, computer vision, sensing capabilities, and autonomous operation

Specifically, the software can have three main package types: communication, sensor handling, and control. Communication packages can be used to link a given unmanned system to another unmanned system or an operator control station over a LAN or internet connection. Sensor handling packages can receive, process, and publish sensor data (i.e., camera feeds, depth data, and temperature data) to the current system and to other network connect devices. Finally, the control packages can leverage both the communication and sensor handling packages to translate messages into commands to control each unmanned system. Each package can have complete functional libraries as well placeholders for including customized code written by users.

According to some aspects, one NEXUS node may be used, and may be configured in control mode and in a robot mode in accordance with disclosed aspects. In some embodiments, a NEXUS node may have an autonomous mode, where a robot node may be programed, and then implemented (e.g., booted up) in a control mode to do what it was programed to do (e.g., from the memory). In some embodiments, there may be a hybrid mode for a NEXUS node, where the node may be programed, and then it can change from robot to autonomous.

According to some aspects, the NEXUS node might not need to be on an uncrewed vehicle. For example, a node (e.g., robot node) may be a weather node or the like which may provide sensor measurements. Such a node might not need a robotic platform or chassis. Such a node may be stationary. A controller device may be able to remote into the node to control it, such as described herein.

According to some aspects, operation components can be grouped into a plurality of collections based on similarity of function between operation components (such as describe above and hereinafter), wherein instructions associated for a function are sent to the collections based on a correspondence between the instructions and a function associated with an associated collection. The collections can include motors, servos, sensor, camera, display, or recording.

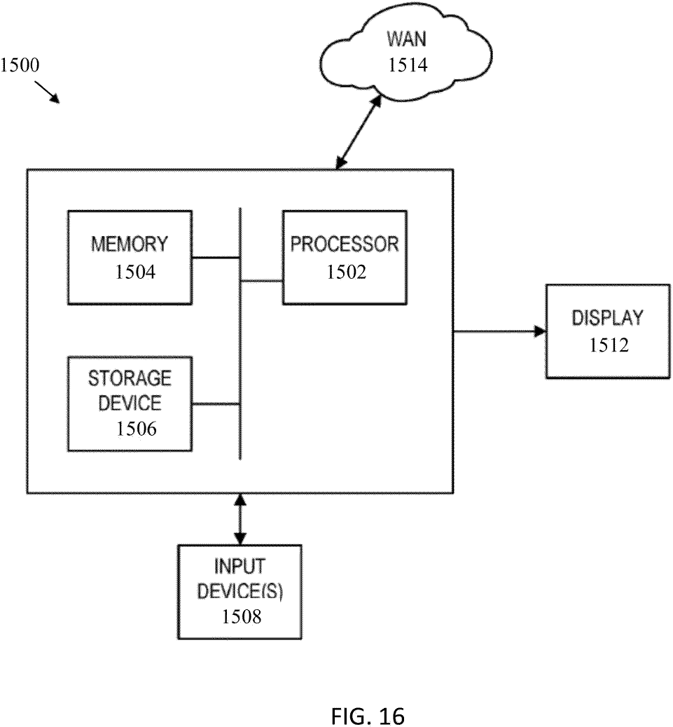

One or more aspects described herein may be implemented on and/or via virtually any type of computer regardless of the platform being used. For example, as shown in FIG. 16, a computer system 1500 includes a processor 1502, associated memory 1504, a storage device 1506, and numerous other elements and functionalities typical of today’s computers (not shown). The computer 1500 may also include input means 1508, such as a keyboard and a mouse, and output means 1512, such as a monitor or LED. The computer system 1500 may be connected to a local may be a network (LAN) or a wide may be a network (e.g., the Internet) 1514 via a network interface connection (not shown). Those skilled in the art can appreciate that these input and output means may take other forms.

Further, those skilled in the art can appreciate that one or more elements of the aforementioned computer system 1500 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for a platform agnostic robotic system has been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

What is claimed is:

1. A system comprising:
a networking device;
a plurality of processing devices;
one or more unmanned devices, wherein each unmanned device couples to a corresponding one of the processing devices, wherein each unmanned device comprises one or more operational components; and
a controller device configured to control at least one of the one or more unmanned devices via the networking device and the corresponding one of the processing devices, the controller device comprising one of the processing devices, wherein the controlled at least one unmanned device is configurable via the corresponding processing device in a control operating mode or in a robot operating mode, the control operating mode enabling the associated unmanned device to perform commands received from the controller device via the corresponding processing device, and the robot operating mode enabling the unmanned device to receive programmable instructions from the controller device via the corresponding processing device;
wherein each of the processing devices comprises memory storing executable instructions, the processing devices being configured to (i) define one or more of the operational components to be used by an unmanned device, (ii) map one or interactive input elements of an input device to a corresponding coded function, and (iii) define one or more actions for corresponding actuations of the one or more interactive input elements;
wherein each processing device is configured with a common software image enabling the controller device to control the one or more unmanned devices responsive to configuring the controller device with an IP address associated with each of the one or more unmanned devices.

2. The system of claim 1, wherein the controller device controls a first of the one or more unmanned devices enabled in a control operating mode;
wherein the common software image enables the controller device to control a second of the one or more unmanned devices responsive to configuring the controller device with an IP address associated with the second unmanned device thereby relinquishing control of the first unmanned device by the controller device by configuring the first unmanned device from the control operating mode to the robot operating mode, and configuring the second unmanned device in the control operating mode enabling control of the second unmanned device by the controller device.

3. The system of claim 2, wherein the second unmanned device is in the robot operating mode prior to being configured in the control operating mode enabling control of the second unmanned device by the controller device.

4. The system of claim 1, wherein the one or more operational components comprises a modular operational component.

5. The system of claim 4, wherein the modular operational component comprises a motor, a servo, a camera, or a sensor.

6. The system of claim 1, wherein the unmanned device comprises a tank, a watercraft, an aerial vehicle, or a car.

7. The system of claim 1, wherein the unmanned device comprises a pump device, thruster, or propulsion device.

8. The system of claim 1, wherein the unmanned devices comprises a mechanical manipulator.

9. The system of claim 1, wherein at least one of the unmanned devices provides depth data or temperature data via a corresponding operational component.

10. The system of claim 1, wherein the memory comprises three files,
wherein the first file defines how the one or more operational components can be used, the second file defines a mapping of interactive input elements of an input device, and the third file defines operational functions corresponding to interactive inputs.

11. The system of claim 1, wherein the one or more operation components comprises a plurality of operational components are grouped into a plurality of collections based on similarity of function between operation components, wherein instructions associated for a function are sent to the collections based on a correspondence between the instructions and a function associated with an associated collection.

12. The system of claim 11, wherein the collections comprises motors, servos, sensor, camera, display, or recording.

13. The system of claim 1, further comprising a display device configured to display the IP address and authentication information associated with a corresponding unmanned device.

14. The system of claim 1, further comprising an environmental device configured to connect to the networking device and configured to impose one or more network-related conditions on the one or more unmanned devices or on the controller device.

15. The system of claim 14, wherein the one or more network-related conditions comprises an increases transmission latency between the one or more unmanned devices and the controller devices.

16. The system of claim 14, wherein the one or more network-related conditions comprises a sampling rate limit for a sensor.

17. The system of claim 14, wherein the one or more network-related conditions comprises a frame rate limit for a camera.

18. The system of claim 1, wherein the one or more actions for corresponding actuations of the one or more interactive input elements are user-defined actions.

19. The system of claim 1, wherein the control operating mode enables the associated unmanned device to perform commands that are preprogrammed and performed by the unmanned device in an autonomous manner.

20. The system of claim 1, wherein the control operating mode enables the associated unmanned device to perform commands based on real-time commands resulting from an input device.
